(19) United States
(12) Patent Application Publication
(10) Pub. No.: US 2015/0088668 A1
(43) Pub. Date: Mar. 26, 2015

(54) WEB-BASED CONTENT AGGREGATION, ORGANIZATION, AND PUBLICATION SYSTEM AND METHODS OF USE

(71) Applicant: Cornell University, Ithaca, NY (US)

(72) Inventors: Thomas Bruce, Ithaca, NY (US); Zachary Doob, Ithaca, NY (US); Adam Palcich, Ithaca, NY (US); Richard W. Anthony, III, Liverpool, NY (US); Vitaliy Darovskikh, Skaneatelis, NY (US); Jennifer L. Campbell, Ithaca, NY (US); Christopher J. Kelly, Ithaca, NY (US); Alfonso Gonzalez, Ithaca, NY (US)

(21) Appl. No.: 14/389,461

(22) PCT Filed: Apr. 3, 2013
(86) PCT No.: PCT/US13/35142

§ 371 Date: Sep. 30, 2014

Related U.S. Application Data
(60) Provisional application No. 61/619,704, filed on Apr. 3, 2012.
(60) Provisional application No. 61/777,850, filed on Mar. 12, 2013.

(51) Int. Cl. G06Q 50/18; G06Q 30/02

(52) U.S. Cl. CPC G06Q 50/184; G06Q 30/0277
USPC 705/14.73

(57) ABSTRACT

The present invention is directed to an improved system and methods of aggregating, storing, organizing, and publishing information. Certain embodiments of the present invention are configured to facilitate easily locating information that has been verified by a system curator. Certain embodiments of the present invention are configured to facilitate easily generating a creation, such as by using an output template.

### PRIORITY STATEMENT

This application claims the benefit of U.S. Provisional Application No. 61/777,850 filed Mar. 12, 2013 and U.S. Provisional Application No. 61/619,704 filed Apr. 3, 2012.

### FIELD OF THE INVENTION

The present invention relates generally to a web-based system that facilitates the management of verified content, possibly of many different types and from many different sources within a larger entity, including organizing content according to topics, distributing content to a pre-selected set of viewers, or offering content to a wider audience. Any system user may select and combine certain portions of the offered content into one or more new creations thereby further extending the usefulness of the content. Advantageously, one embodiment of the system is configured such that the content originates within or is sourced by an organization thereby permitting consumers of the content to make use of it without engaging in one or more additional time-consuming verification steps to determine the content's origin and therefore accuracy or authenticity.

### BACKGROUND OF THE INVENTION

The World Wide Web (also, the “Web”) is a global information medium operating over the Internet that provides content which users can view and a location to which consumers can add content via computers connected to the Internet. Websites, established at first by individuals and organizations simply to provide content to the public, now are used for two-way and group communications and direct Web-based commerce (e-commerce). A website is now considered to be the most important tool by which organizations can provide promote and market themselves.

Given the interest in and use of it, the World Wide Web has an enormous scope—measured in the tens of billions of webpages. To assist consumers in locating the content they are seeking, the content is indexed. Indexing this much content so that consumers can readily find that which they are seeking is a challenge not only because of the volume of new content added constantly to the system but also because the indexing strategy must be sufficiently robust to anticipate every current and possible new relationship which consumers may associate with the content. How this indexing works and therefore how best to search the Web to find certain content is not altogether known by most consumers. As a result, most consumers typically guess what query will best locate the content they are seeking.

Searching on the Web is facilitated by some resources that provide content regarding more general topics and hyperlinks to subtopics of relevance to the given general topic. Wikipedia is one such resource. Wikipedia is a multilingual, web-based encyclopedia project that permits volunteers to submit articles and update and offer edits to the same article or the articles that others have submitted. Wikipedia articles provide hyperlinks to other Wikipedia articles or non-Wikipedia originated content or articles. Wikipedia currently offers over 22 million articles in some 285 languages, over 4 million of which are in the English language.

If an article regarding a certain general topic is located, whether it likely provides all the information sought by the consumer depends on whether the article provides a narrow view or a broad view of the given general topic. Unless many knowledgeable people collaborate in developing the article on the general topic, an article may simply provide a narrow range of information and possibly not that which the consumer seeks.

If the first article that is located by the consumer does not provide all the information sought by the consumer, or an article on the general topic is not located at all, the consumer must continue the search. Search engines often assist with searching a set of information (e.g., a website or the entire Web) for relevant information. The reports provided by such search engines sometimes identify only a list of hyperlinks and/or an excerpt from each of the webpages it has identified as potentially relevant based on the search query. To ascertain the purpose and scope of content provided on each webpage, the consumer must open and review each webpage. The result list is typically ranked based on what the search engine determines is most relevant. Generally, the search results are not categorized based on content topics.

If, after reviewing the search result entries that the search engine ranks as most likely to be relevant, the consumer finds that most of the webpages do not provide the information that the consumer wishes to find, the consumer may run another search with a new search query and repeat the process of glancing over the results list and excerpts and opening and reviewing any webpages that appear promising.

From these efforts, the consumer may be able to assemble a body of information that the consumer believes is relevant to the broader target topic. However, even after engaging in this time consuming, multi-step process, the consumer cannot know with any certainty whether the body of information that the consumer has located is everything relevant to the broader target topic that is available on the Web.

Separate and apart from locating any information on the Web is the issue of whether the information that the consumer is able to locate is accurate. For example, an article may appear on the Web that may purport to offer certain facts. However, because content can be created for and posted to the Web anonymously or pseudonymously, a consumer may not know the author of the article and, therefore, may not be able to determine whether the author is likely to have firsthand knowledge of the facts, or is simply providing an opinion regarding the facts, or is retelling another author's opinion of the facts. Similarly, an article appearing on the Web may purport to provide a quote from a work. Unless the consumer locates the original work, the consumer will not know whether the quote is accurate or not. Errors are often created and perpetuated in this way on the Web. Even a Web resource such as Wikipedia does not guarantee that the information found there is accurate; instead, it guarantees there is a consensus that the information is believed to be accurate. A consumer seeking to correct information found in a Wikipedia article can do so only if Wikipedia editors believe that the proposed correction is line with the consensus regardless whether the consensus of opinion is, in fact, accurate.

Consumers who are more familiar with the workings of the Web know that, before they can rely on the content offered there, they must verify the accuracy of what they have read or seen. Verification of the accuracy of the content located on the Web can be a time consuming process. Consumers engage in the process until: they believe they have located the primary source of the content; or have located some authoritative confirmation that the subject content is accurate; or simply run out of time. The overall lack of confidence in the accuracy of much of the content found on the Web makes it a less reliable source of information relative to traditional sources.

A demand therefore exists for a system and methods by which content regarding a wide variety of topics and subtopics may be made available through the Web, all of which originates with an original source or is verified as being accurate. The present invention satisfies the demand.

### SUMMARY OF THE INVENTION

The present invention is a system and methods by which content regarding a wide variety of topics and subtopics may be provided, all of which originates with an original source or is verified as being accurate. For purposes of this application, an “original source” is the person, entity, or device that created, discovered, developed, generated, and/or organized the content. The invention is particularly useful to an organization that wishes to provide content on a wide variety of topics and subtopics to system users who can use it with confidence relative to the other content available on the Web and without engaging in time consuming verification.

For purposes of this application, an “organization” means a person, legal entity, group, or body. Also for purposes of this application, a “system user” means a person who directly accesses the system, a person who obtains content from a person who directly accessed the system, or a person who performs some or all of the steps of the invention.

Also for purposes of this application, the term “publishing”—and the term “publication” when used to describe an action—means making content available to one or more people, a specific group of people, a subset of an organization, an entire organization, anyone with access to the system, anyone with access to the Web, or anyone without restriction. Publication may include passively making the content available for one or more people to access at their convenience or actively directing content to a specific person or group of people. The offering to distribute content to a group of persons for purposes of further distribution, public performance, or public display constitutes publication. A public performance or display of content also constitutes publication. For purposes of this application, the term “publication” when used to describe a thing means the result of the act of publishing.

One example of an organization that may use the invention to provide content regarding a wide variety of topics may be a prolific author. For purposes of this application, an author is any person or entity that has created or developed any subject matter including that which can be published or offered through the use of the Web or other computer-facilitated system. Some such authors may produce written or graphic subject matter. Others may produce static or moving pictures. Another group of authors may produce sound. An additional group of authors may produce a mixture of such types of content. The content may concern one or more topics. The invention is configurable such that the author's content can be segregated and identified according to topic and subtopic. A consumer seeking to locate that which an author has created, discovered, developed, located, or otherwise prepared on a given subject can quickly locate that content even though the content may have appeared, for example, in many different primary sources such as an article or a book or expressed in a blog or interview or in a video clip or sound file. A user can use the content confidently and without further verification of the contents' accuracy because the consumer knows, by accessing the content through the system, that the author either created the content or obtained the content from another source, and therefore implicitly approves the accuracy of the content.

Another example of an organization that may use the invention to provide content on a wide variety of topics may be a legal entity. A university is one of the many such legal entities that may use the invention. On a daily basis, a university produces a large and varied volume of content, including data, notes, text, articles, descriptions, catalogs, press releases, audio files including music, lectures, and speeches, recordings for distance education purposes, recordings of artistic and athletic events, and generally still and moving images.

However, despite the fact that the university has an interest to show the public the range and details of the scholarly and related activities that take place on campus, or because of the university has limited resources, only a very small amount of information regarding these activities ever is made available to the public through a single, easily accessible resource such as the university's website. Instead, the information regarding such activities is traditionally offered to the public through a variety of general outlets—including the university or local newspaper, the alumni newsletter, local access cable television, and radio—and specific resources—including public presentations and speeches, and books, academic periodicals, and other sources of primary literature. University websites typically provide only a limited range of content. Largely, such web content is that which universities typically made available in analog form, such as background descriptions, course catalogs and outlines, explanatory materials for students and staff, forms, policy statements, and maps. New forms of content such as sound files, video files, or real time feeds from monitors or cameras are provided, if at all, only sporadically through the university website. As a result, some observers have concluded that universities could, but have not used their websites as effective tools to improve their reputations as places of scholarship and to satisfy their moral (and possibly legal) obligation to provide the results of the scholarly research taking place on campus.

Separate and apart from the task of trying to locate information regarding a specific topic is the task of trying to locate the most current information on a variety of topics for an entire organizational system. For example, universities typically offer only a limited amount of current information, such as one or more press releases and possibly some additional hyperlinks, but not organized by topic or subtopic. Other content may be found but only through additional, time consuming searching of the university website and each of the different colleges, departments, laboratories, staff, faculty members, and possibly students that provide hyperlinks. However, even after engaging in such an extended search of a university website, consumers may not know whether all the most current content regarding a particular subject has been identified and overall what is the most current content produced by the university system-wide.

Another organization that may use the invention to provide content on a wide variety of topics may be a legal entity such as a corporation. Like universities, large or multi-national corporations constantly produce a large volume of content. Unlike universities, corporations do not produce content with the ultimate goal to make it all public. Corporations produce content largely for internal use and not for public dissemination. However, just because corporations exert more control over the content they produce does not necessarily mean that those within the corporations can more easily locate the content they are seeking on a particular subject. Because the content may be produced by different offices, affiliates, or subsidiaries of the parent corporation that may be located in different regions, and by staff members speaking different languages, content regarding even the same subject originating with the corporation may not be easy to locate. It is often difficult to determine what is the most current content produced by the corporation regardless of the topic.

Other types of organizations that may use the invention to provide content on a wide variety of topics include governmental bodies—such as municipal, ward, district, borough, county, state, regional, or national governmental organizations—political parties, associations, foundations, societies, tribes, teams, or groups.

Many large organizations have a decentralized communications structure, that is, one in which content is produced and managed within each of the organization's administrative structures. As a result of this decentralization, content may come to reside in what may be termed “information silos”; these are, portions of an organization's website that are accessible only as a subtopic related through an organizational structure and not one through a subject matter structure. The extent to which information is lodged in such silos is not typically apparent to someone seeking content through a website. Consumers seeking to determine whether the organization has content on a specific topic can try to satisfy this inquiry only by attempting to identify each of the information silos that may have some information of relevance to the topic, then searching each of the silos.

The system of the present invention includes an origination component, a curation component, and a publication component. With respect to the origination component, content made available through the system can come from one or more sources, which are also termed “originators” for purposes of this application. An originator may be the creator of the content or may someone who identifies the content as relevant or useful and submits it to a curator for the curator's review or other original source. An originator also may be a device or system.

For example, one source of the content—that is, an originator—may be equipment set up by the organization to capture and provide content including data to the system. Such equipment can include one or more cameras or sound monitors or recorders that capture video and/or sound. In certain embodiments of the present invention, the captured content may be “tagged”—that is, identified by topic and/or subtopic—then either distributed (or “streamed”) to users who have identified they have an interest in receiving such content when available or offered to users who can access it when they wish. The content may also be saved in the content repository and tagged for possible access later by topic or subtopic through the system.

To illustrate the use of an embodiment of the present invention in which the system obtains content from a camera, the camera may be placed, for example, at one or more sites to capture images and sound from one or more events. Such events may take place at the same time but at different locations and be made available to one or more viewers (after the camera content is received in the content repository and tagged) who wish to have the opportunity to view and/or hear one organizational event while attending another event. Such events may also take place at different times, and some or all the content recorded in stored in the content repository as tagged for later access. The captured content is identified by tagging it and made available through one or more topics or subtopics established in the system. In one specific application, such cameras and sound monitors are placed by the organization in order to capture content that will be distributed for distance education purposes such as an online course. In another application, the necessary equipment is placed to capture and distribute content from a swim meet or a field hockey match or even a public lecture to one or more viewers who may be attending a football game in which the university team is playing at the same time as the other event is taking place.

Other pieces of equipment—additional examples of originators—through the use of which an organization can obtain content for the system are data monitors or collectors. The data may be received in the content repository, and automatically or manually tagged by topic and/or subtopic, and either distributed to one or more users (who have identified an interest in the data) or offered to users for access. Such distribution or offering may take place generally contemporaneously with the data collection or later from data saved in the content repository. In one specific application, the data collector may be a thermometer, rain fall gauge, wind gauge, or seismograph that provides data about environmental or planetary events through a topic or subtopic established in the system. In another specific application, the data collector, an originator through which data is collected, may be a piece of laboratory equipment with the content—for example, information regarding the status of the collection effort or the data itself—being sent to a user generally contemporaneously or from storage in the content repository. Examples of such laboratory equipment may include heat sensor, light sensor, sound sensor, weight sensor, pressure sensor, magnetism sensor, electricity sensor, a particular motion sensor, or other type of sensor.

Content for use in the system according to the present invention may be provided also by one or more human originators who may produce written or graphic subject matter, static or moving pictures, sound, or a mixture of such types of content. Examples of written subject matter include non-factual based stories, factual based stories, news stories, press releases, and/or editorials. Examples of static or moving pictures include photographs, slides, and movies.

Content for use in the system may be not only that which is produced within or by an organization but also that which originates outside the organization. Such content may be, for example, news stories, or static or moving images produced by an entity outside the organization that are selected by one or more persons within the organization—an originator—for inclusion in the system because of the content's relevance to the organization, the content's accuracy, and/or the outside entity's reputation. Because users trust the organization, the users trust that the organization will provide accurate content which they can access and use the content without engaging in the time consuming verification process necessary for content obtained from an unknown source.

Certain embodiments of the system and methods permit a user to search the published content by entering a search query. A search may identify content associated with that which was identified in the search query by evaluating only the tags, evaluating only the keywords, evaluating tags and keywords, or evaluating any combination of tags, keywords, text in the content, or other information extracted from the content.

A search report provided by the system has certain advantages over known search reports. Known search engines typically provide a report that lists only a URL (uniform resource locator) and an excerpt of the website. A search report according to the present invention may identify any or all tags including a topic or a subtopic of the content. In certain embodiments, the search report also may display an arrangement of the search results according to the relationship between the topics and subtopics. The search results may be arranged by topic/subtopic first, then within each category further ranked by relevance of the content to the search query. An arrangement of search results may include a flowchart, a Venn diagram, idea map, outline, newsletter, or other graphical representation of the relationship between the subtopics. For example, if a search was done for “swimming”, the search result may depict a top-level topic of “Swimming” and a plurality of subtopics such as “Swimming strokes”, “Swimming lessons”, “Swimming pools”, “Local swimming teams”.

In certain embodiments, an application programming interface (API) is provided to allow other programs to read and write to the system.

In certain other embodiments, content may be catalogued by automated cataloguing, including by “crawling” the content and identifying “keywords” in the content. Then, the system attempts to match “keywords” with existing tags. More specifically, if a keyword is identical to or similar to a pre-existing tag, such tag may be added to the content. If a keyword is not identical or similar to an existing tag, the keyword is used for searching and ranking purposes, but is not treated as a tag for purposes of the taxonomy system.

The curation component of the present invention subjects the content produced within or obtained from outside an organization to one or more management activities. One management activity is associating a source identifier with each unit or subunit of content in the system, if an identification of the source is not implicit within the subunit. For purposes of this application, a “source identifier” may include what is termed a “link” or what is termed an “information icon” or “pop-up”. A link identifies the source of the content. In certain embodiments, a link may include a hyperlink, bookmark, applet, bookmarklet, Serial Item and Contribution Identifier (SICI), digital object identifier (doi), QR code, or bar code, each of which may lead to the actual source of the content, a retailer of the source, or other information about the source. In other embodiments, a source is identifiable by opening a pop-up or information icon that provides some information about the source of the content or how the user may find more information about the source (e.g., source title, source author, source owner, source ISBN, source call number, full citation link, source trademark, or other reference information).

In certain embodiments of the system of the present invention, content whose primary source is known—for example, because it originates within the organization—may be automatically assigned a source identifier either upon creation of that content or upon dispatch to or receipt by the curator. Another embodiment of the present invention assigns a source identifier to content that originates outside the organization only if and when the identity of the outside source and the content's accuracy are verified and possibly whether the necessary permission or license to use the content in the system is confirmed. Such verification and confirmation management activities will be performed by one or more system curators. A curator may be a person, tool, or device, each of which may include a subject matter expert, an information classification expert (e.g., librarian), an investigation expert who knows how to verify information, an expert on the organization's structure or objectives, a program configured to apply verification criteria to content, or other appropriate entity.

Embodiments of the system and methods that permit adding content that originates outside the organization advantageously allow an organization to obtain and use content, for example, from another organization—that is legally distinct and independently generates its own content—yet which users consider being related or relevant to a topic. One example of legally distinct organizations that may be related in the minds of users is a university and a research foundation, each of which may bear similar names. Each is a legally distinct operation. Each generates its content generally independent of the other. But because the activities of one is often relevant to, or as a consequence of the work done by the other, users consider them closely related and would benefit in being able to access content produced by both through a single website resource.

Another management activity to which content will be subjected is the organization of the content into the priority areas established within the system. These priority areas can include those organized by topic or subtopic.

An additional management activity to which the content will be subjected is the arrangement of the organized content into units that are acceptable for publication through the Web. More specifically, content may be obtained or received as a “subunit”, for example, a hyperlink, a digital file such as a document, text, email, image, video, a website tab, quote, news story, feed, data packet, advertisement, or footer of a website, or a non-digital object such as a document, image, or specimen, or other format. The curator may build a unit from the one or more subunits. For purposes of this application, the term “unit” may be a content page such as a webpage acceptable for publication for the Web, document acceptable for publication via email, or other format configured to facilitate publication to users of the system or efficient storage of the content in the repository. Each unit may include all information from a topic, subtopic, lower level classification, portions of a classification, or any set of content that the curator deems suitable for the system.

Another management activity is the collection of data regarding what content pages users are accessing, what the users are doing with the content, overall anticipating which users may have an interest in what current content or new content, organizing the content in light of such actual or anticipated interests, and offering to users such content, including by sending communications to one or more users about the content that may be of interest to them.

An additional management activity is organizing the content such that not only the most current content can be viewed but also the content that existed at a content page or webpage as of a given date.

Another management activity is providing selective access to curated content to certain system users. For example, a curator may provide access to certain content to only a select group of users and not grant or deny access to that certain content to all other users.

An additional management activity is developing and applying criteria for verifying content so that users do not have to do so. Such criteria may include determining whether the source is reliable or assessing whether the actual content is reliable. To determine whether a source is reliable a curator may examine whether the content is or includes a primary source, find out whether the source always applies peer-review or editorial review, investigate whether the source was internal to the organization, detect whether the source has provided verified content in the past and whether the source was pre-approved for future submissions, learn whether there is some other reason to trust that the content is reliable without further review of the content.

To assess whether the actual content is reliable, the curator may complete one or more or a combination of the following: investigate whether the content was created by a member or members of the organization; research whether the content has been approved by a member or members of the organization; consider whether the content was subjected to or approved after a peer-review process; establish whether the content was subjected to or approved after an editorial review process; ascertain whether the content has been authorized by a subject matter expert; ask subject matter expert to review and approve the content; cross-check the content with other information; conduct observations, calculations, or experiments related to the content; discern whether content includes appropriate citations; ascertain whether any copyright, contract rights, or other legal rights may limit rights to publish the content; or discover whether content is an opinion or other information not meant to be true or false.

For purposes of this application, a “primary source” is information recorded or provided by someone with personal knowledge of or a device with direct access to the topic, subtopic, or subject to which the content is related. A primary source may include a specimen, an original document, a creative work, or other object or information.

For purposes of this application, a “citation” is a reference to a source and may be formatted according to Modern Language Association (MLA) style, American Psychological Association (APA) style, American Sociological Association (ASA) style, Oxford style, Columbia style, Chicago Manual of Style (CMS), Turabian style, Uniform Citation Standards, The Bluebook style, Association of Legal Writing Directors (AWLD) style, Modern Humanities Research Association (MHRA) style, Canadian Guide to Uniform Legal Citation style, Oxford Standard for Citation of Legal Authorities (OSCOLA) style, American Chemical Society (ACS) style, American Institute of Physics (AIP) style, Institute of Electrical and Electronics Engineers (IEEE) style, Pechenik Citation style, parenthetical referencing, Vancouver referencing, a hybrid style, or a new style. A curator may select any style of citation and review the content for compliance with the style. A curator also may assess the citations for mere consistency within the content.

Any and all of such criteria may be used by the curator to determine whether to publish the content and/or, in some cases, whether to store the content in the repository.

A curator may apply additional criteria that may be unrelated to reliability for verification of the information. For example, if a curator wishes to add only information related to a specific topic or organization, a curator may choose to reject the content even if the content is verified.

Another management activity is considering for pre-approval certain sources as originators for the system and providing them with direct access to the publication component and/or repository. For example, if a curator evaluates a specific source so that it can become a system originator and determines that such source is reliable and likely to provide only reliable, verified content, the curator may pre-approve such source. Accordingly, subsequent content submitted by such pre-approved source/originator may be published via the publication component without additional review by the curator (since the curator already subjected the source to a first level of curation) or may be reviewed by the curator only sporadically or systematically for quality assurance purposes. Other content is evaluated at both the first level of curation (e.g., evaluating the source/originator) and a second level of curation (e.g., evaluating the content itself).

An additional management activity is appraising the content's technical characteristics and eliminating content that does not have certain technical characteristics. For example, in some embodiments, the content published by the curator must be in digital format or hosted on a website before it is published. In other embodiments, the curator may convert the content to a digital format or host the content on a website managed by the curator.

Another management activity is identifying (i.e., “tagging” for purposes of this application) the content by topic or subtopic. Of course, the system may include additional levels of categorization beyond topic and subtopic categories (e.g., sub-subtopics and categories below such subtopics). Topic or subtopic classifications may be a part of a larger taxonomy, such as the Library of Congress classification, Dewey Decimal classification, Colon classification, Universal decimal classification, British catalog of music classification, Dickinson classification, NLM classification for medicine, Swedish library classification (SAB), biological taxonomy, or a custom taxonomy configured specifically for the content that a curator believes will be published or stored in the system. The taxonomy may be static (such that the classification categories generally do not change over time) or may be dynamic such that categories can be added, deleted, combined, or divided with the approval of the curator. In certain embodiments, each unit or subunit of content is tagged by topic and/or subtopic. A tag also may include the identity of the source of the content. For purposes of this application, a tagged unit or subunit that has been approved (either directly by approving the content or indirectly by approving a source) for publication or storage by the curator is termed a “curated element”.

An additional management activity may be, not only, reviewing and verifying information as it is received, but also seeking and obtaining content that is or may be desired for a webpage or other unit in the system. For example, a curator may find that certain topics or subtopics are not populated with any or with sufficient content or may receive requests for content regarding a certain topic or subtopic, and accordingly, seek or obtain such content.

The system and the methods of the present invention include also a publication component. Once the curators have developed content pages or other units from the tagged content, the system makes the content pages available to users through the Web for viewing or other use. Each such content page or content unit may retain identification of the original source. In certain embodiments, the published webpage includes only a source identifier and related tags, but not any of the content associated with such source identifier. An example of such an embodiment includes a list of hyperlinks associated with a specific topic or subtopic. In other embodiments, the published webpage includes not only a source identifier and related tags, but also a summary or portion of the content. In still other embodiments, the published webpage includes a source identifier, tags, and all of the content.

Users can view the content found on a content page and customize the content to create versions that are, for example, publishable, printable, faxable, distributable as emails, or otherwise exportable from the system. Certain embodiments of the system and methods permit a user to request an automatic notification when a certain type of unit or subunit (e.g., a unit or subunit with a specific tag) is added to the system or periodic notifications regarding selected content added to the system. A periodic notification may be useful for a department of the organization that has monthly meetings. Each department member may sign up for a notification regarding new content added to the system relevant to that department one day before each monthly meeting. Such notifications may include a title, summary, tag, link, or other information regarding the newly added content. Also, certain embodiments may permit a user to create an output identifying of all content added (to the entire system, to a certain webpage, to a certain category or tag) since the last time the user signed in, since the last time the user created an output, for a certain date range entered by the user, or other time period.

Certain embodiments of the system permit users also to select one or more portions of one or more content pages to produce new versions of the content. For example, the system permits users to prepare a simplified version of an original content page by selecting only a portion of the content on the content page and creating a new content page which the user can further use. The system permits a user to prepare also a more complex version, such as by adding new content to a portion of or all an original content page or selecting and combining content from two or more content pages. In addition to the content located on a content page, the system permits users to search for and incorporate in a new version that content which has been approved for use in the system but which may have not fully been presented in one or more content pages and/or is stored in the content repository for use by users.

Certain embodiments of the present invention permit users to identify their interest in or comments regarding content found on content pages. Such ratings and reviews can be published with the content to provide feedback to other users.

An additional embodiment of the present invention permits the curators to provide their own rating or comments regarding content found on content pages. Such comments, for example, can place the content in a larger context so that users can better understand or appreciate the content. The curator ratings can be developed independent of or as a result of any ratings or comments received from system users.

Another embodiment of the present invention saves the data, comments, and reviews in the content repository for possible access by curators and/or users separate and apart from that which is published. Through such information, those using the content can independently determine the accuracy of the ratings that are actually published with the content.

In addition to those identified above, a variety of advantages are associated with the present invention. One such advantage is that it permits users to access content that users trust and use such content in new creative efforts. Because of that trust, users may be more willing to expend more time and effort in developing new and lasting creations.

Another advantage of the system and methods of the present invention is that it permits users to use the verified content to develop and offer to other users a wide range of creations. These new offerings may be as simple as copying some or all the content from a content page and submitting it to the system curators for possible additional designation under a new topic or subtopic. This permits content to be made accessible to users which may find the new topic or subtopic to be more relevant than that under which the content was originally categorized. This additional offering may increase the size of the audience for the content.

Also, users can use the content found at the website to create fully customized user-generated components for any permissible purpose, including, for example, fundraising, e-newsletter generation, fact-finding, documentary, marketing, or personal interest. Certain embodiments may be configured specifically for such a purpose and accordingly, may include customizable templates for output of verified content. For example, if a user wishes to build a monthly newsletter, a user may import some or all content from one or more pages into the template. In certain embodiments, the template is configured to arrange the content automatically according to relevance, user preference, or size onto the template. Each template may be configured for publication via paper, for digital publication, or for both paper and digital publication. Other templates may be configured to provide types of output other than newsletters, such as a presentation (e.g., PowerPoint presentation or Keynote presentation), a word processing document, a spreadsheet document, a graphic representation, a meeting agenda, promotional materials, a pamphlet, an electronic book (e-book, or a paper book. Another embodiment of an output may include a widget configured to be embedded in an external website. That widget is configured to dynamically display information related to a certain topic or subtopic.

A template may be configured to permit the user to choose individually each curated element added to the output. Also, a template may have a “single action” (e.g., single click, single keystroke) option configured to create an output including all content having a certain quality (e.g., certain tag or certain combination of tags). Certain templates may be configured to reformat a webpage or other type of unit already in the system for a specific type of output, e.g., for printing, faxing, emailing, or otherwise providing the content to another user of the system or an entity outside of the system. If a template is not available for the output that the user wishes to create, the user may either create a new template or create a free-form output.

Certain embodiments of a template include branding information, e.g., organization identification configured to convey the identity of the organization, curator identification configured to convey the identity of the curator, both of which illustrate that the content has been generally verified by the curator or the curator's organization. Advantageously, such brand may become a valuable asset for the curator or organization and enhance the reputation of the curator and the organization as a whole.

An additional advantage of the system and methods of the present invention is that it provides users with a reputable means by which they can distribute the creative content which the users prepare. These creations will be distributed through the use of the system as content pages. Because the new creation has as its starting point the content found on one or more content page, users looking for the original content and creations prepared will be able to identify it readily.

Another such advantage of the system and methods of the present invention over known systems is that it permits organizations to provide a wider range of content to users in a context that is easy to search and access. The content identified by topic and subtopic eliminates the need for users to search first through administrative headings, then for information silos in which the content may be placed. Large organizations including universities will benefit from the use of the invention because users can easily and efficiently determine that which the organization has produced or is in the process of producing.

An additional advantage of the system is that it permits a content page to be created which would provide at least a “snapshot” of what is occurring at the organization at the moment. As a result, users will no longer have to make an extended search of each administrative heading under which information is placed in traditional websites to determine what is new at the organization.

Other advantages of the present invention include that a content page can be used as a single web page. Also, a content page can be created and placed on a website that is not within the context of the organization's website.

In certain embodiments, an information system according to the present invention may be built in ColdFusion 9, on an Apache/Unix server with an Oracle database. The system may be replicated by copying the code on a similar environment, or the software could be modified to run from “the cloud” as a service in which the Institution maintains the code and other uses would deploy from there. Third party software used in the development may include jQuery Javascript Library, jQuery Tools, and jQuery.

Certain embodiments of the present invention address various technical problems. One technical problem relates to the time consuming process of finding a broad scope of verified content. Often, content is arranged in what may be termed “information silos”, which are portions of an organization's website that are accessible only as a subtopic related through an organizational structure and not one through a subject matter structure. The extent to which information is lodged in such silos is not typically apparent to someone seeking content through a website. Consumers seeking to determine whether the organization has content on a specific topic can try to satisfy this inquiry only by attempting to identify each of the information silos that may have some information of relevance to the topic, then searching each of the silos. For example, if a corporate officer wishes to obtain information about an organization's product, information about the product's development may be available under a first silo directed to “Research and Development”, cost and income information may be available under a second silo directed to “Accounting”, prospects for future sales information may be available under a third silo directed to “Sales”, and information about regulations that apply to the product label may be available under a fourth silo directed to “Regulatory Compliance”. Clearly, it is time consuming to obtain a broad scope of relevant information about a product because such information is stored separately in each information silo.

A solution to the technical problem includes an embodiment of the system and methods according to the present invention in which content is tagged at least by topic or subtopic such that a system user can easily and quickly identify every piece of content relevant to or related to each topic or subtopic. Such embodiments may include a search function and search report configured to facilitate quick and easy identification of such content.

The present invention and its attributes and advantages will be further understood and appreciated with reference to the detailed description below of presently contemplated embodiments, taken in conjunction with the accompanying drawings.

### BRIEF DESCRIPTION OF THE DRAWINGS

The preferred embodiments of the invention will be described in conjunction with the appended drawings provided to illustrate and not to the limit the invention, where like designations denote like elements, and in which:

FIG. 1A illustrates a certain system embodiments of the present invention;

FIG. 1B illustrates a certain system embodiments of the present invention;

FIG. 2A illustrates a flow diagram of an embodiment of the present invention;

FIG. 2B illustrates a flow diagram of an embodiment of the present invention;

FIG. 2C illustrates a flow diagram of an embodiment of the present invention;

FIG. 2D illustrates a flow diagram of an embodiment of the present invention;

FIG. 3A illustrates an embodiment in which content is combined into units and then tagged by topic and/or subtopic;

FIG. 3B illustrates another embodiment in which content is combined into units and then tagged by topic and/or subtopic;

FIG. 4A illustrates an embodiment of a method of the present invention;

FIG. 4B illustrates another embodiment of a method of the present invention;

FIG. 5A illustrates an additional embodiment of a method of the present invention;

FIG. 5B illustrates another embodiment of a method of the present invention;

FIG. 5C illustrates an additional embodiment of a method of the present invention.

FIG. 5D illustrates another embodiment of a method of the present invention;

FIG. 5E illustrates an additional embodiment of a method of the present invention;

FIG. 5F illustrates another embodiment of a method of the present invention;

FIG. 5G illustrates an additional embodiment of a method of the present invention;

FIG. 6 illustrates yet another embodiment of a method of the present invention;

FIG. 7 illustrates an exemplary computer system according to the present invention;

FIG. 8 illustrates an exemplary cloud computing system according to the present invention;

FIG. 9 illustrates an embodiment of a user interface of the system configured to permit exchanging messages with users of the system, building an output, and obtaining content;

FIG. 10 illustrates an embodiment of a user interface of the system configured to permit curating content;

FIG. 11A illustrates a user interface embodiment of the system showing an output creation template for an e-book;

FIG. 11B illustrates a user interface embodiment of the system showing an webpage;

FIG. 12A illustrates a user interface embodiment of the system configured to permit entry of a search query and search results display;

FIG. 12B illustrates another user interface embodiment of the system configured to permit entry of a search query and search results display;

FIG. 12C illustrates an additional user interface embodiment of the system configured to permit entry of a search query and search results display;

FIG. 12D illustrates a user interface embodiment of the system configured display search results;

FIG. 12E illustrates another user interface embodiment of the system configured display search results; and

FIG. 13 illustrates a user interface embodiment of the system configured to deliver an index of topics and subtopics in the system taxonomy.

### DETAILED DESCRIPTION OF EMBODIMENTS OF THE INVENTION

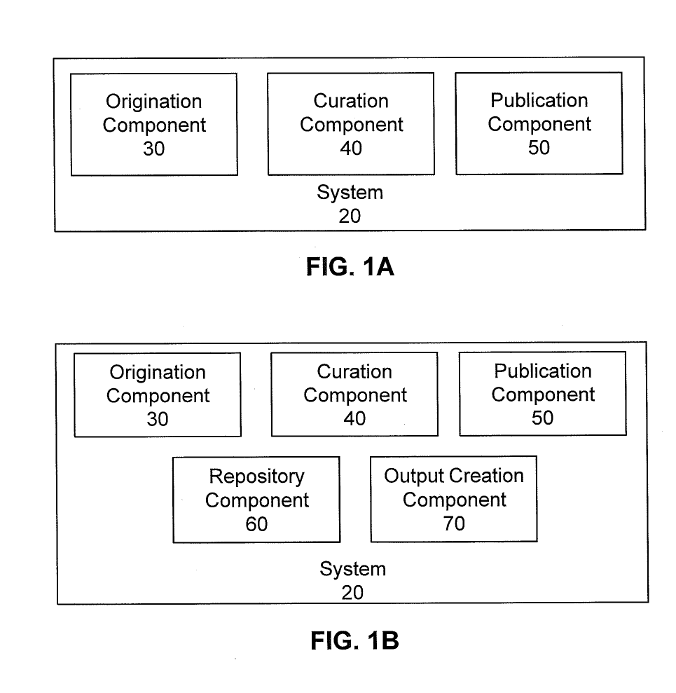

Certain embodiments of the system 20 and methods of the present invention include an origination component 30, a curation component 40, and a publication component 50 as illustrated in FIG. 1A. Additional embodiments may include a repository component 60 and an output creation component 70 as illustrated in FIG. 1B.

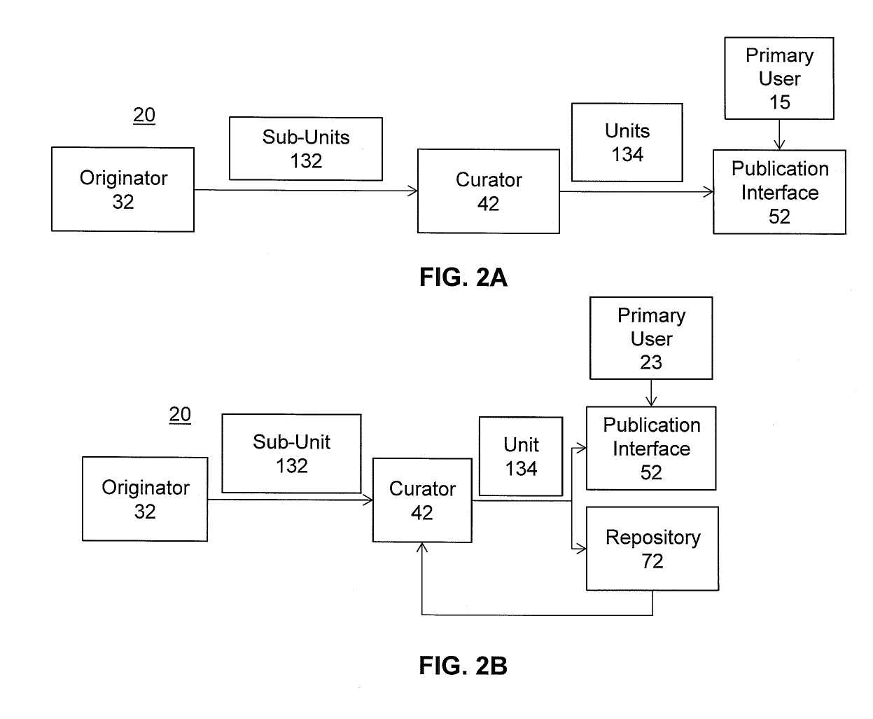

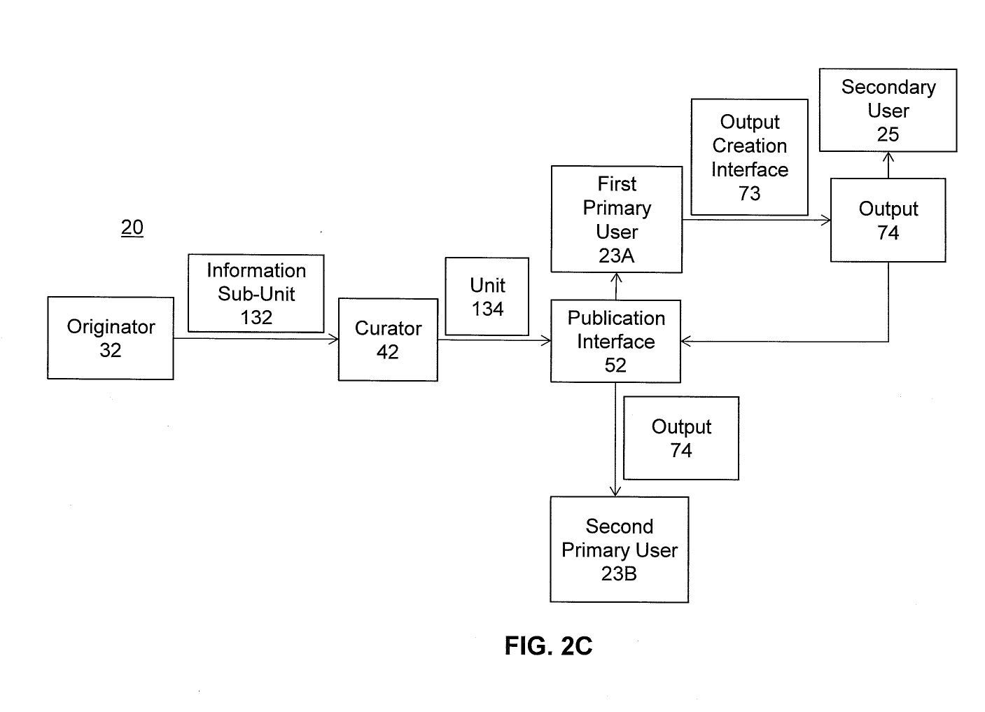

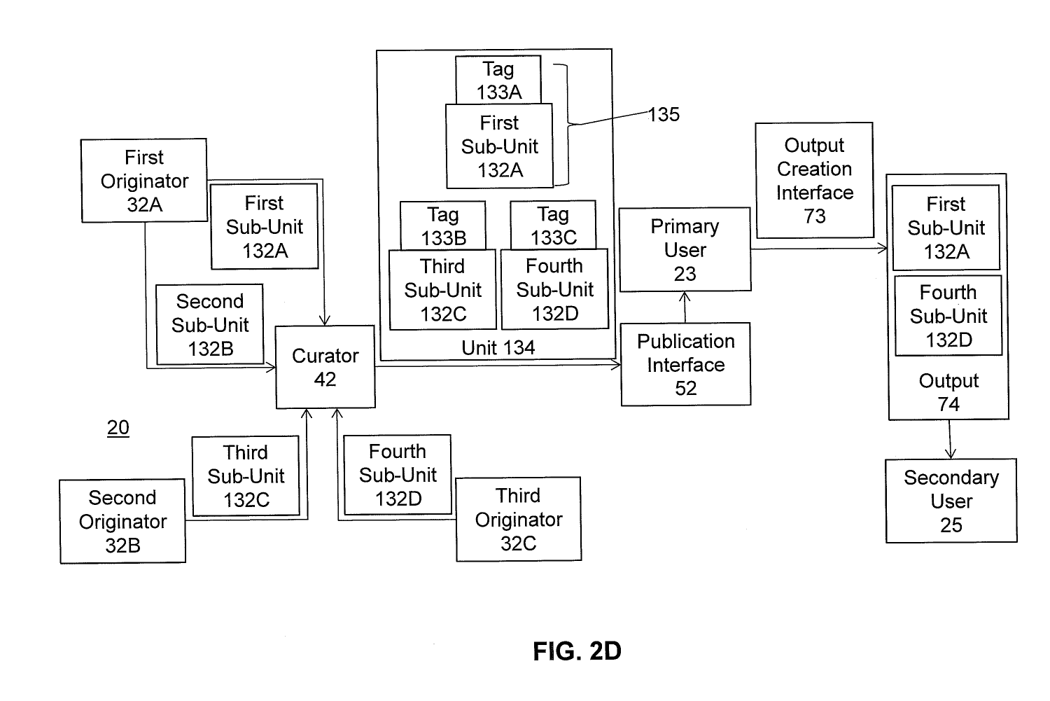

In general as illustrated in FIG. 2A-FIG. 2D, a curator 42 may receive or obtain content in the form of subunits 132 from an originator 32. The curator 42 may determine which subunits are verified, and using the verified subunits, build one or more units 134 from the one or more subunits 132. Each unit 134 may be published in the publication interface 52 and made available to users, including a primary user 25. Each unit 134 also may be stored in a non-public repository 72 or a public repository (not shown). Certain units 134 are published and stored within the system, only published within the system and not stored within the system, or only stored within the system and not published within the system. Some content also is not published and not stored within the system, but typically such content is discarded before there a unit is generated from such content. For the content that is published within the system and not stored within the system, the system typically stores only a link to such content, and the complete set of content is stored outside of the system. For example, the system may offer the content only via a hyperlink to an external website or intranet site on which content is hosted.

As illustrated in FIG. 2C, a first primary user 23A—that is, the first entity to extract content from the publication interface 52—may create an output 74 using an output creation interface 73 from the units 134 in the publication interface 52. The output 74 may be further distributed to a secondary user 25 and also may be published via the publication interface 52 and accessible to a second primary user 23B.

As illustrated in FIG. 2D, a curator may obtain or receive content subunits 132 from more than one originator 32. The curator 42 may apply tags 133 to the subunits 132 which become curated elements 135 after curation, and selectively combine such curated elements 135 into a unit 134.

Again with reference to the origination component 30 illustrated in FIG. 1A and FIG. 1B, content made available through the system 20 can come from one or more sources. The content may be provided to a curator via the origination component 30 in computer readable format or a non-computer readable format.

A computer readable format may include a webpage, portion of a web page, or digital file (e.g., digital data file, digital image file, digital audio file, digital video file, digital text file, digital presentation file, compressed digital file), each of which may be sent automatically, e.g., via an Rich Site Summary (RSS) feed or other notification element, or sent manually, e.g., via email or other message sent by an originator or via portable storage device (compact disc, DVD, Blu-ray Disc, USB flash drive, jump drive, hard drive, SIM card, SD memory card, floppy disk, or other storage devices known in the art) that is physically transferred to the curator. When the curator receives content in a computer readable format, the curator may input the content into a curation component 40 manually or the curation component 40 may automatically place the content in temporary storage or permanent storage.

A non-computer readable format may include paper, canvas, cloth, sculpture, print photograph, or other format not readable by a computer. When the curator receives information in a non-computer readable format, the curator may convert the content or at least a portion of the content into a computer readable format before inputting the content into the curation component 40. Examples of converting the content may include scanning the non-computer readable format using a scanner, taking a photograph or video using a digital camera, or hosting the content on a webpage.

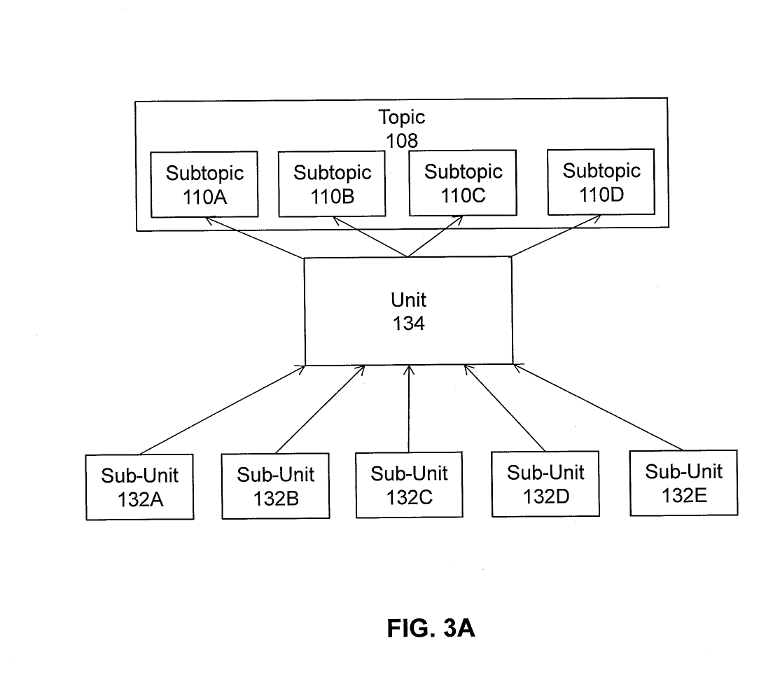

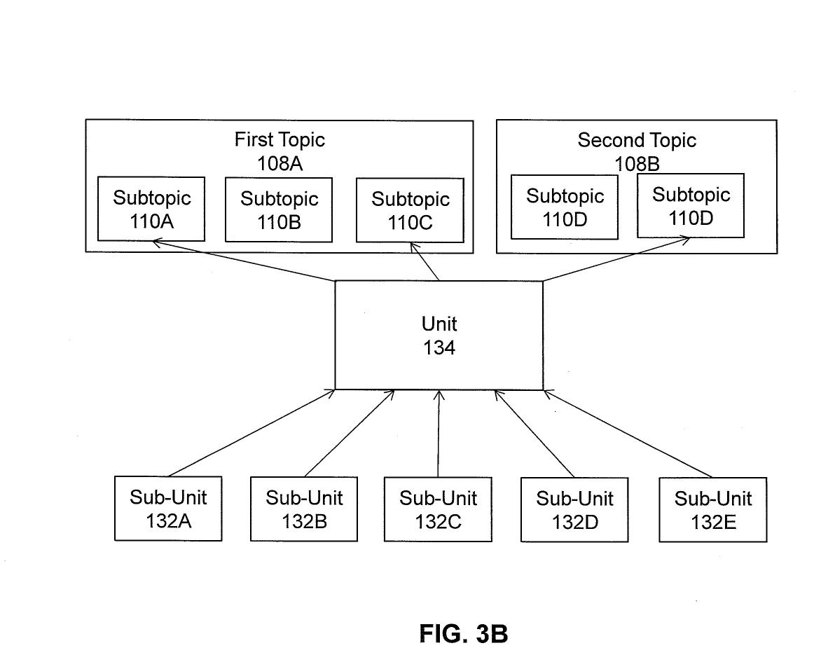

After receiving the content and, if necessary, converting the content to a computer readable format, the curator may use a curation component 40 to subject the content produced within or obtained from outside an organization to one or more management activities. As illustrated in FIG. 3A, each content unit may be tagged with at least a topic 108 or a subtopic 110 and optionally may be tagged also with information such as the source, author, curator, legal publication limitations, citation, date of creation, or date of addition to the content management component. Such information may be metadata. As illustrated in FIG. 3B, each unit 134 may be tagged with a first topic 108A and a second topic 108B and various subtopics 110 within each topic 108. The topic 108 or subtopic 110 is identified from a system taxonomy developed in light of the organization's goals or the anticipated user objectives. The taxonomic categories—that is, topics, subtopics, or additional levels of classification—may be selectable from a user interface in the curation component 40. Also, one or more of the users may suggest new taxonomic categories for addition to the options available for selection. One or more curators may ultimately review and approve such suggestions.

The content may be manually tagged or automatically tagged. Manual tagging may occur by permitting the originator or user to suggest and/or the curator to approve or select from a set of pre-determined tags. Such tags may be stored in a database accessible by or within the system. Each tag may be associated with one or more units/subunits of content and each unit/subunit of content may be assigned one or more tags. Automatic tagging of content may occur by configuring the system to assign a specific tag or set of tags with all content having certain characteristic (e.g., assign date stamp tag to all content received on a certain date, assign source tag or topic tag to all content from a specific source, assign a URL tag to all content available at a specific URL). Another form of automatic tagging may occur by cross-referencing or associating keywords (found by crawling the content or otherwise extracting information from the content) with available tags, and applying tags found to be relevant based on the keyword comparison. Such automatic tagging may use HTTP calls to access the URLs stored in the database for each piece of content in order to acquire the original source for the content. The system may then store the HTML from that source. From there, a search engine (e.g., internal search engine or third party search engine) may review the stored HTML portion of each piece of content and provide relevant keywords which will be stored in a manner making that piece of content searchable by those keywords.

The system and the methods of the present invention include also a publication component 50. Once the curators have developed content pages from the tagged content retained in the content repository, the system 20 may make the content pages available to users through the Web for viewing, searching, or other use. Each such content page may retain a hyperlink to the original source.

In certain embodiments, the publication component 50 is configured to provide directed distribution of content or public distribution of content. For example, if a user wishes to distribute a content page to a specific person or group of people, but not make it publicly available, the content page may be designated as “private” and made accessible to the specific person or group of people via email to the targets, using a password to access the private content, or other way of sharing content with limited access.

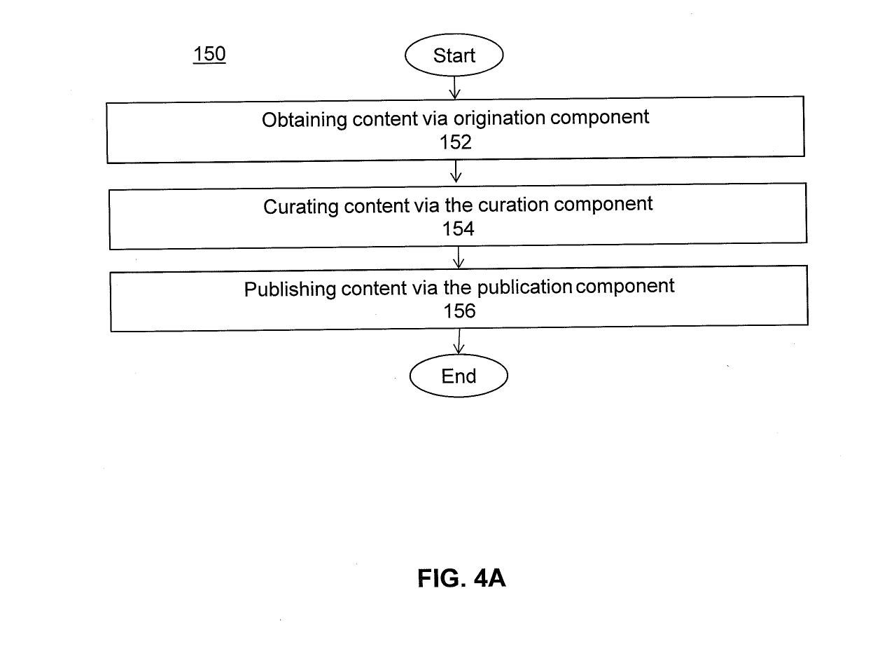

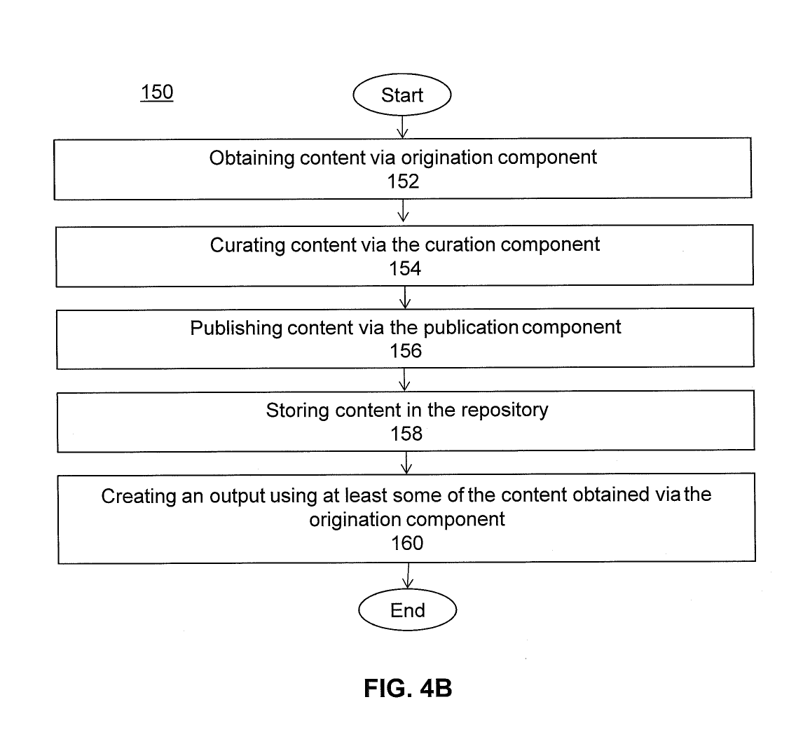

FIG. 4A illustrates a simplified method embodiment 150 of the present invention. In such embodiments, a curator obtains content via an origination component 152. The curator then curates the content via the curation component 154. Then the curator publishes the content via the publication component 156. As illustrated in FIG. 4B, a curator also may store content in the repository 158. Also, a user may create an output using at least some of the content obtained via the origination component 160.

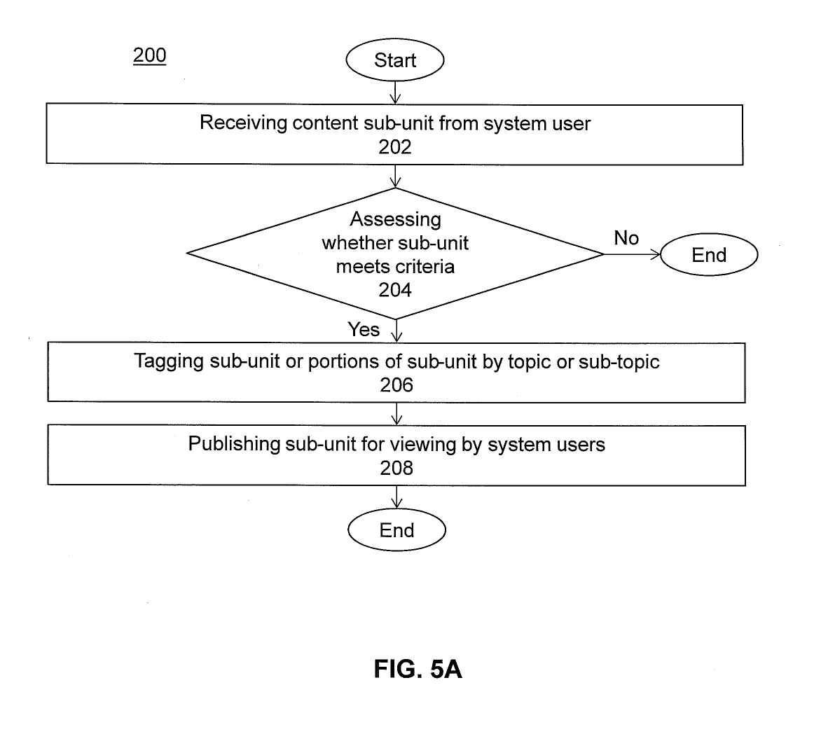

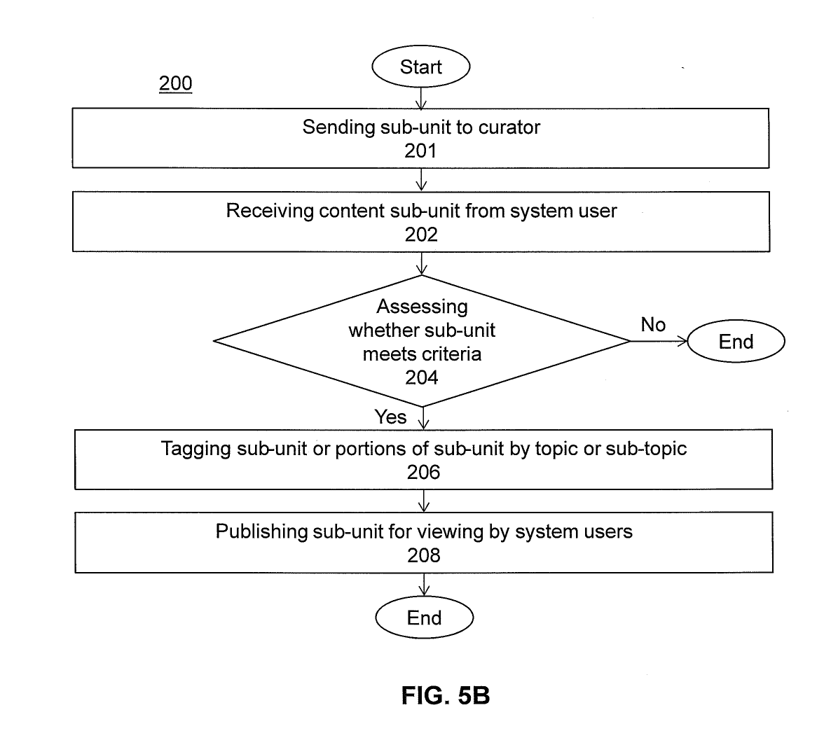

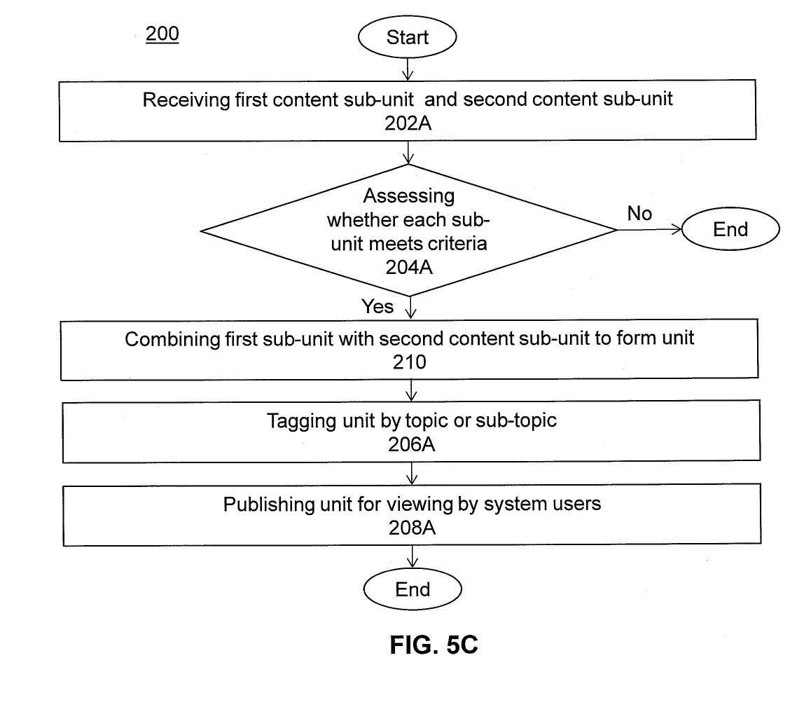

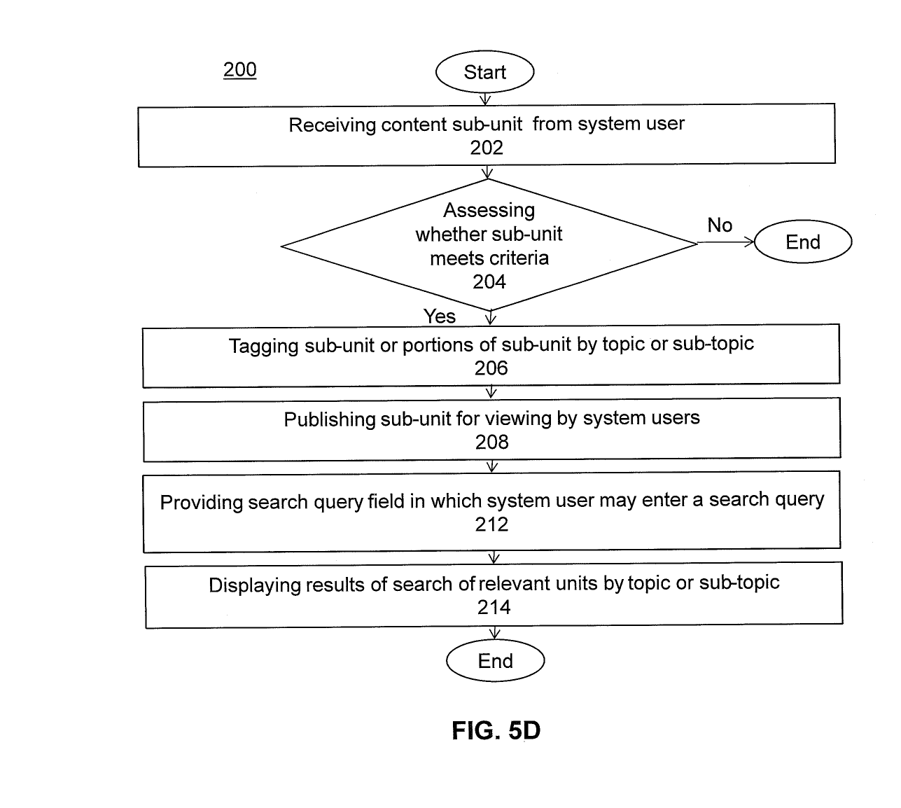

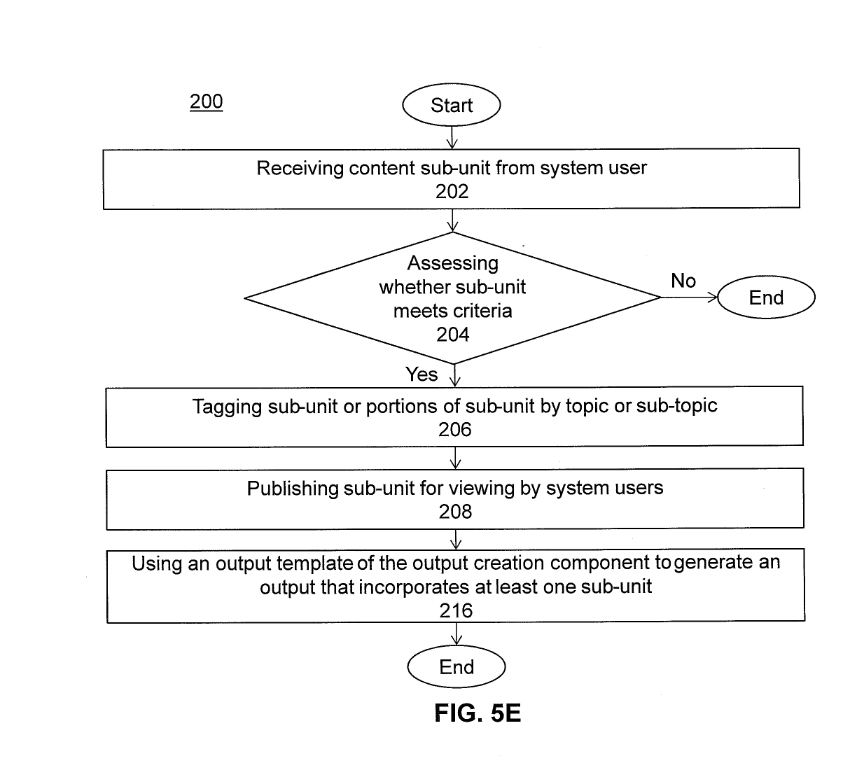

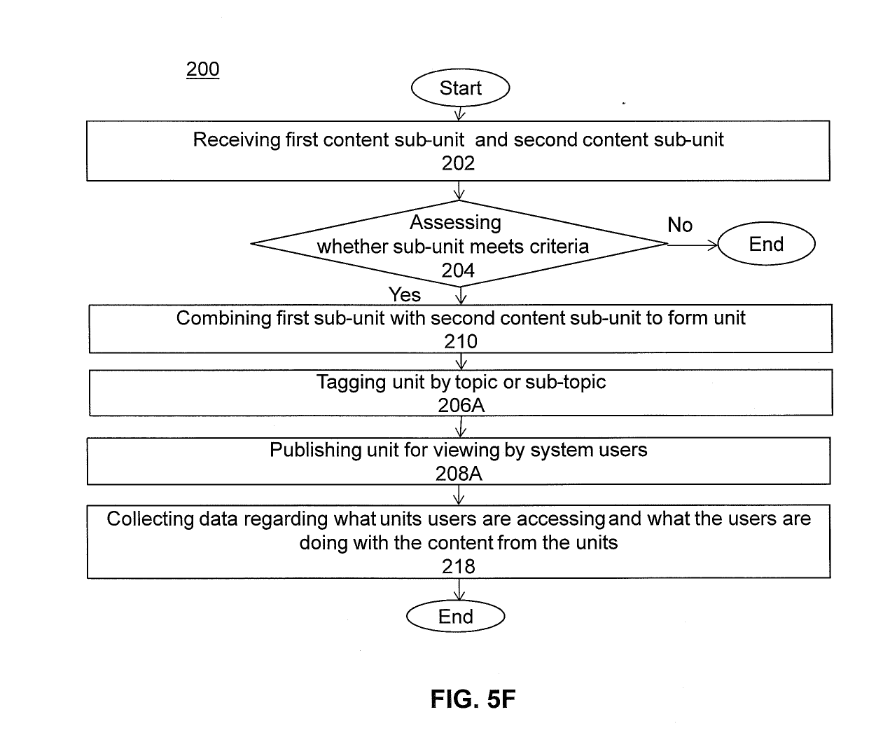

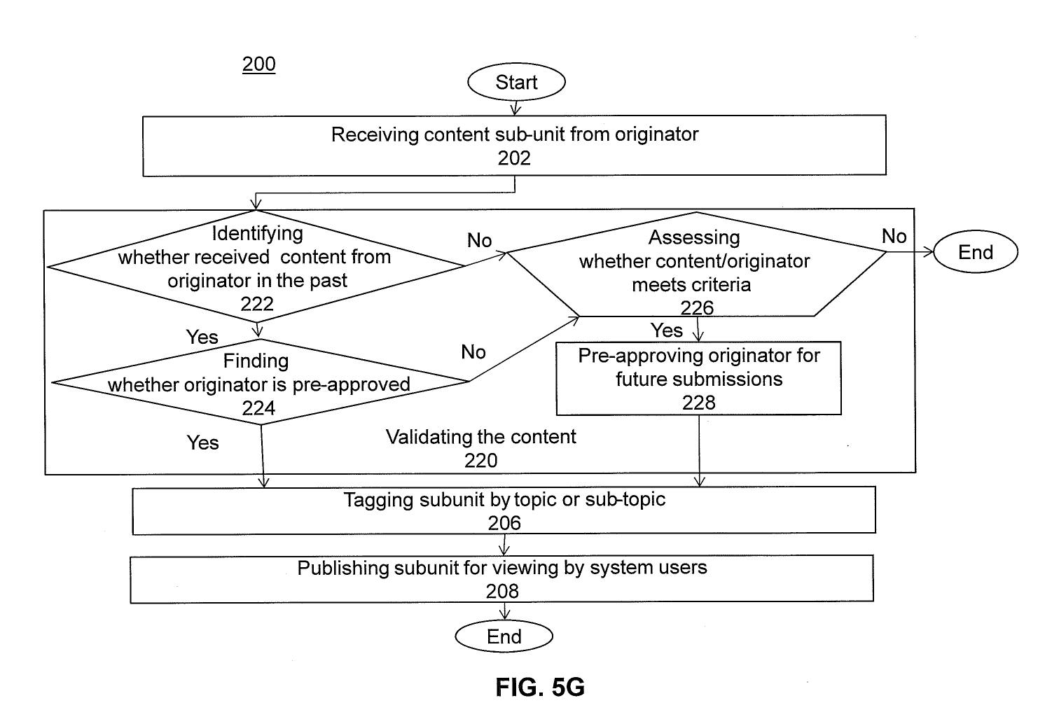

FIG. 5A-FIG. 5F illustrate additional method 200 embodiments of the present invention. For example, in certain embodiments, a curator may be offered or receive content from a user (and user may be an originator) 202. Then, the curator may assess whether the content meets criteria such as validity criteria 204. If the content does not meet the criteria, the process may end. If the content does meet the criteria, the curator tags the content at least by topic or subtopic 206. The tagged content—that is, a curated element—is published 208.

FIG. 5B illustrates an additional embodiment of the present invention which further includes a step in which a user sends content or a portion of content (e.g., a link) to a curator 201.

FIG. 5C illustrates a method embodiment in which the curator has received or obtained a first subunit and a second subunit of content 202A and the curator combines the first subunit with the second subunit of content to form a unit 210. The unit is then tagged 206A and published 208A.

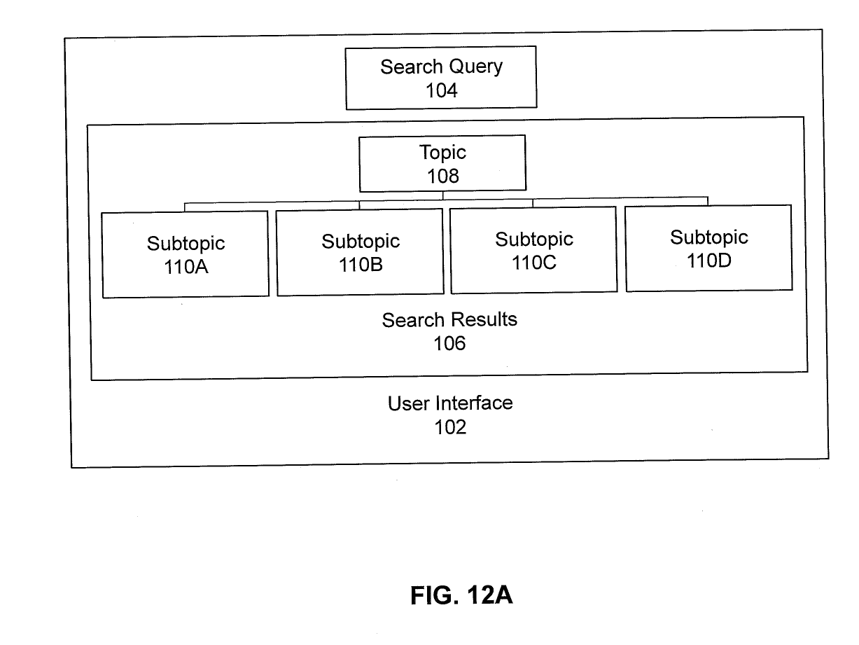

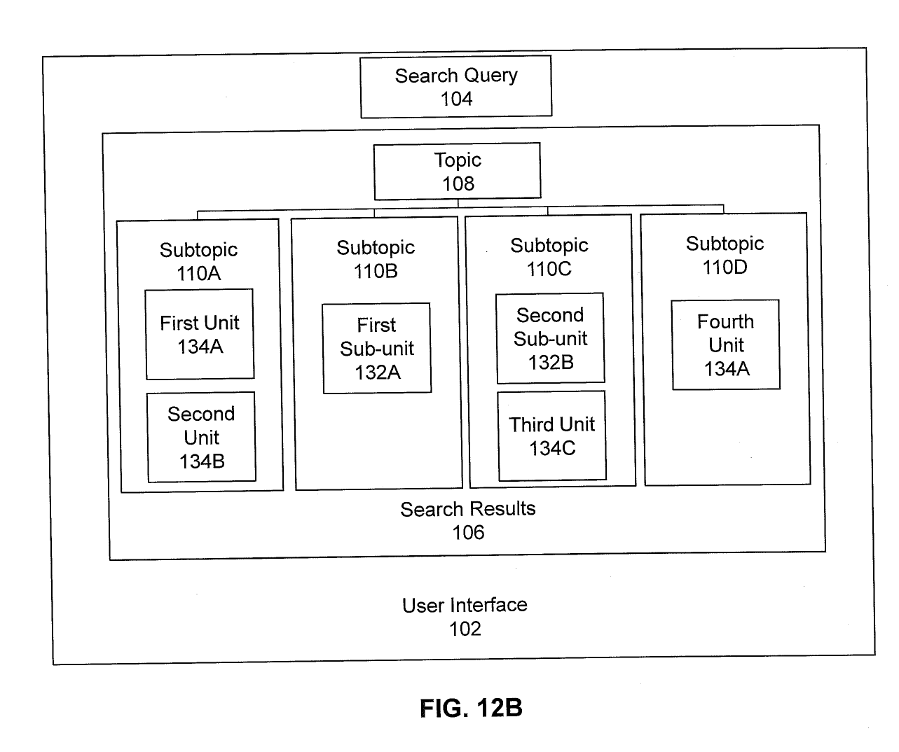

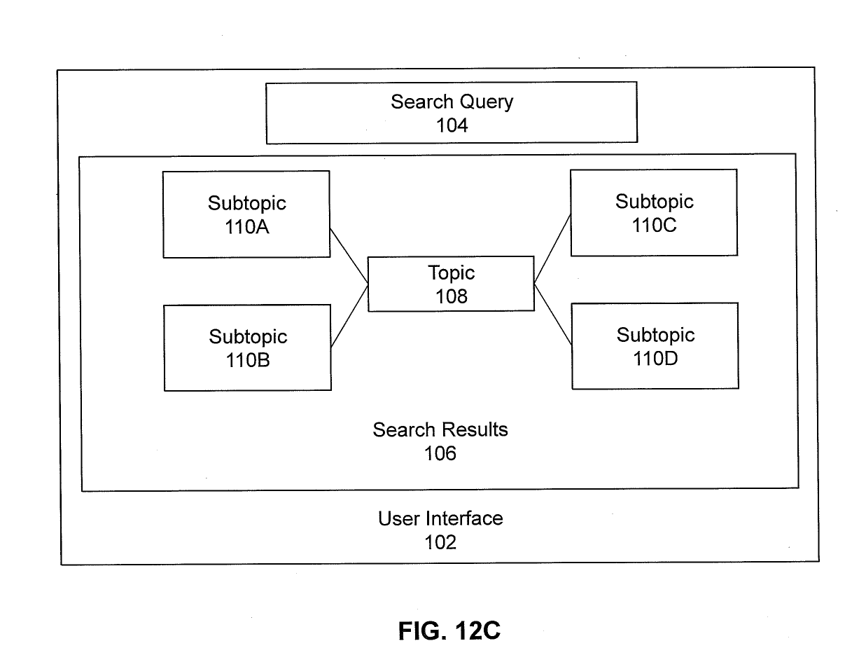

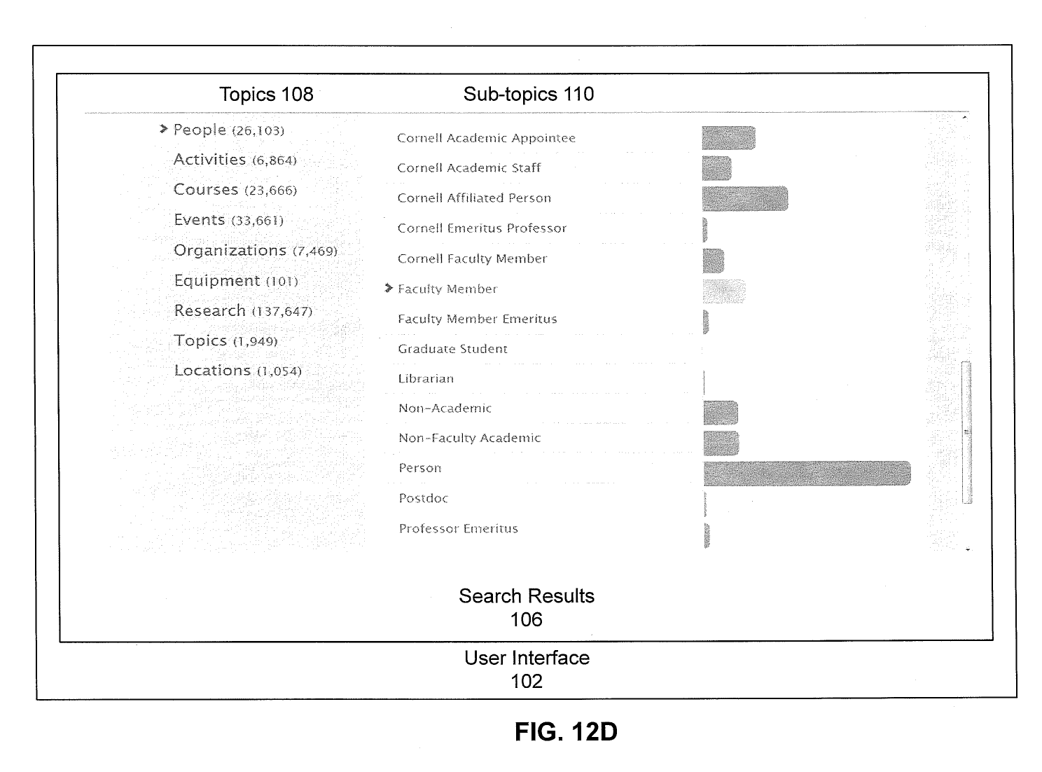

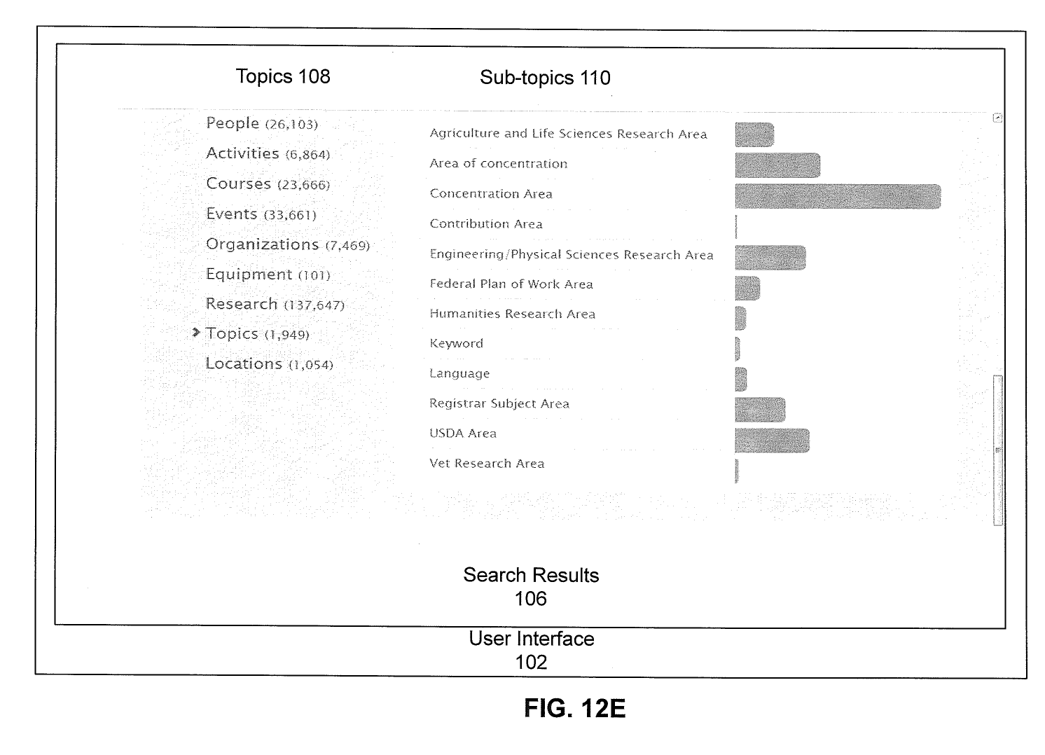

FIG. 5D illustrates a method embodiment which comprises the step of providing a search query field in which a user may enter a search query to search the published content 212 in addition to the steps illustrated in FIG. 5A. Such an embodiment also may permit exhibiting search results by displaying a topic or sub-topic 214. Examples of such a display is illustrated in FIG. 12A-FIG. 12E.

FIG. 5E illustrates a method embodiment in which a system user uses an output template to generate an output that incorporates at least one subunit 216 in addition to the steps illustrated in FIG. 5A.

FIG. 5F illustrates a method embodiment in which the system collects data regarding how users are accessing the units and what the users are doing with the content from the units 218 in addition to the steps illustrated in FIG. 5C.

FIG. 5G illustrates a detailed embodiment of validating the content 220. Such validating step 220 may include identifying whether the curator has received content from the originator in the past 222. If the curator has not received content from the originator in the past, the curator assesses whether the content and/or the originator meets the criteria 226. If the content and/or originator meets the criteria, the curator may pre-approve the originator for future submissions 228. However, in certain embodiments (not illustrated), just because the curator validates some content from one originator does not mean that all content from that originator will be pre-approved for later publication or storage. If the originator has been pre-approved 224, the content is tagged 206 and published 208.

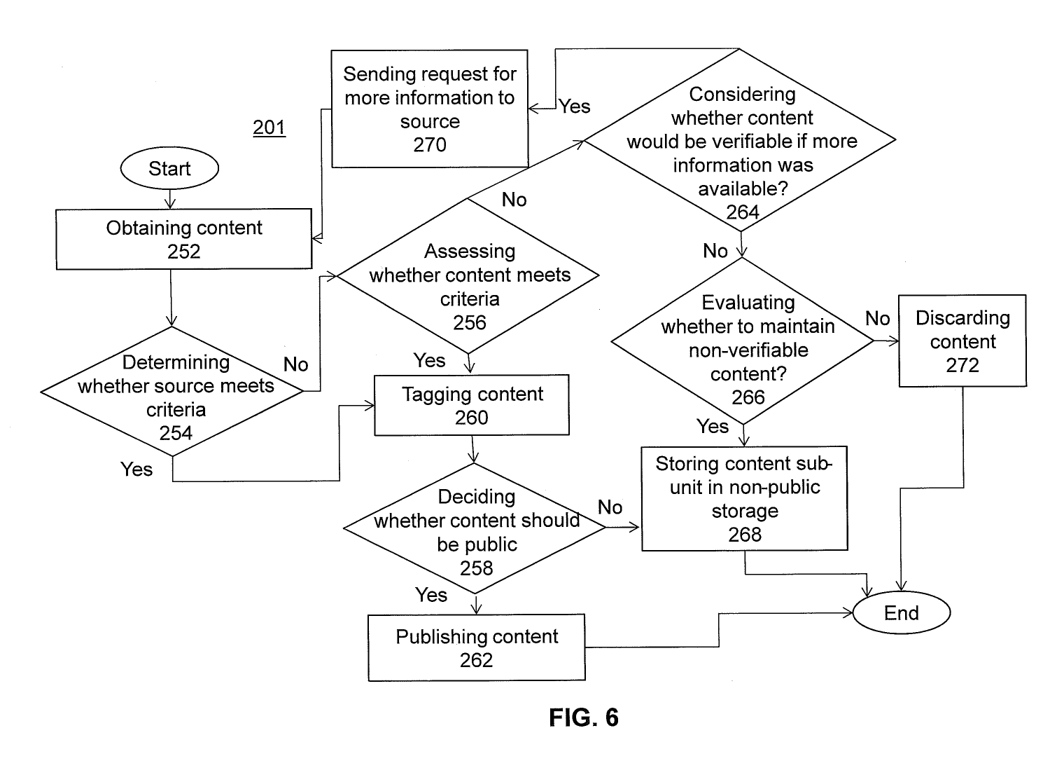

FIG. 6 illustrates another embodiment of a method 201 according to the present invention. In such embodiments, a curator obtains content 252 and assesses whether the source meets the criteria 254 (e.g., in some embodiments, such source criteria may include whether the source is internal to the organization, whether the source is subject to editorial or peer-review). If the source does not meet the criteria, the curator determines whether the content meets the criteria 256. If the content meets the criteria, the content is tagged 260. The curator then determines whether the tagged content should be public or non-public 258. If public, the curator publishes the content 262. If non-public, the curator stores the content in non-public repository 268. However, if the content does not meet the criteria, the curator optionally considers whether the content would be verifiable if more information was available 264 and, if so, may send a request for more information to the source 270. If the content would not likely be verifiable even with more information, the curator evaluates whether to maintain non-verifiable content 266. If the curator wishes to maintain non-verifiable content 266, the content is stored in a non-public repository 268. If the curator does not wish to maintain non-verifiable content, the content is discarded 272.

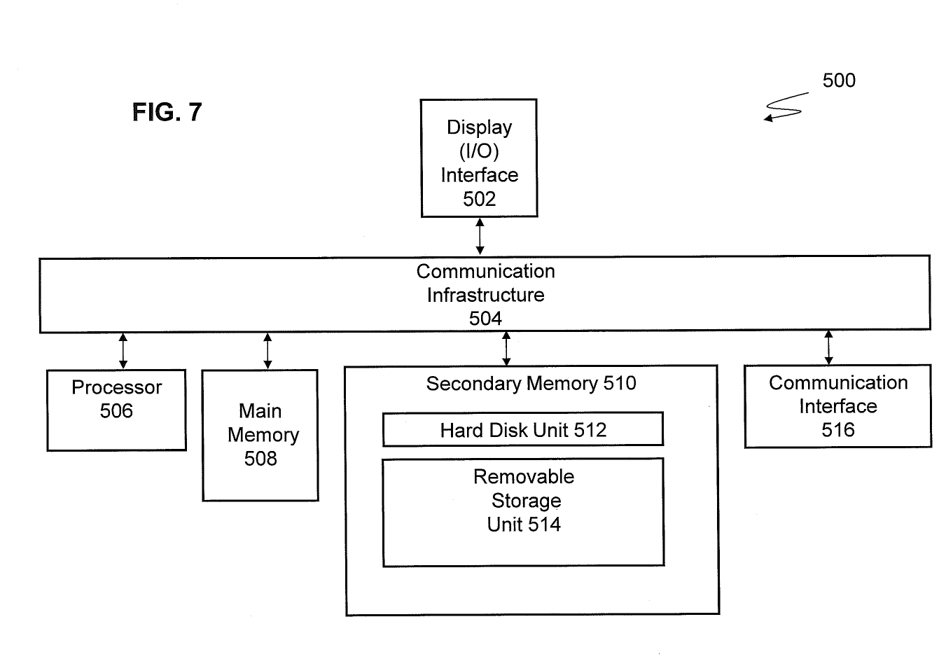

FIG. 7 illustrates an exemplary computer system 500 that may be used to implement the methods according to the invention. One or more computer systems 500 may carry out the methods presented herein as computer code.

Computer system 500 includes an input/output display interface 502 connected to communication infrastructure 504—such as a bus —, which forwards data such as graphics, text, and information, from the communication infrastructure 504 or from a frame buffer (not shown) to other components of the computer system 500. The input/output display interface 502 may be, for example, a keyboard, touch screen, joystick, trackball, mouse, monitor, speaker, printer, any other computer peripheral device, or any combination thereof, capable of entering and/or viewing data.

Computer system 500 includes one or more processors 506, which may be a special purpose or a general-purpose digital signal processor that processes certain information. Computer system 500 also includes a main memory 508, for example random access memory (“RAM”), read-only memory (“ROM”), mass storage device, or any combination thereof. Computer system 500 may also include a secondary memory 510 such as a hard disk unit 512, a removable storage unit 514, or any combination thereof. Computer system 500 may also include a communication interface 516, for example, a modem, a network interface (such as an Ethernet card or Ethernet cable), a communication port, a PCMCIA slot and card, wired or wireless systems (such as Wi-Fi, Bluetooth, Infrared), local area networks, wide area networks, intranets, etc.

It is contemplated that the main memory 508, secondary memory 510, communication interface 516, or a combination thereof, function as a computer usable storage medium, otherwise referred to as a computer readable storage medium, to store and/or access computer software including computer instructions. For example, computer programs or other instructions may be loaded into the computer system 500 such as through a removable storage device, for example, a floppy disk, ZIP disks, magnetic tape, portable flash drive, optical disk such as a CD or DVD or Blu-ray, Micro-Electro-Mechanical Systems (“MEMS”), nanotechnological apparatus. Specifically, computer software including computer instructions may be transferred from the removable storage unit 514 or hard disc unit 512 to the secondary memory 510 or through the communication infrastructure 504 to the main memory 508 of the computer system 500.

Communication interface 516 allows software, instructions and data to be transferred between the computer system 500 and external devices or external networks. Software, instructions, and/or data transferred by the communication interface 516 are typically in the form of signals that may be electronic, electromagnetic, optical or other signals capable of being sent and received by the communication interface 516. Signals may be sent and received using wire or cable, fiber optics, a phone line, a cellular phone connection, a Radio Frequency (“RF”) connection, wireless connection, or other communication channels.

Computer programs, when executed, enable the computer system 500, particularly the processor 506, to implement the methods of the invention according to computer software including instructions.

The computer system 500 described herein may perform any one of, or any combination of, the steps of any of the methods presented herein. It is also contemplated that the methods according to the invention may be performed automatically, or may be invoked by some form of manual intervention.

The computer system 500 of FIG. 7 is provided only for purposes of illustration, such that the invention is not limited to this specific embodiment. It is appreciated that a person skilled in the relevant art knows how to program and implement the invention using any computer system.

The computer system 500 may be a handheld device and include any small-sized computer device including, for example, a personal digital assistant (“PDA”), smart hand-held computing device, cellular telephone, or a laptop or netbook computer, hand held console or MP3 player, tablet, or similar hand held computer device, such as an iPad®, iPad Touch® or iPhone®.

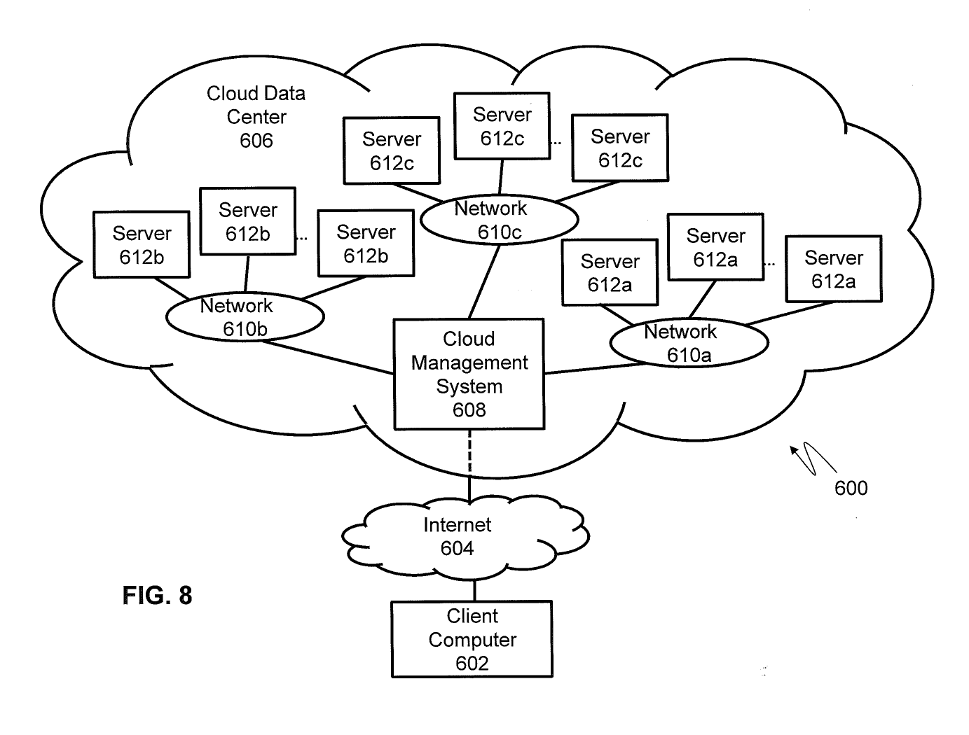

FIG. 8 illustrates an exemplary cloud computing system 600 that may be used to implement the methods according to the present invention. The cloud computing system 600 includes a plurality of interconnected computing environments. The cloud computing system 600 utilizes the resources from various networks as a collective virtual computer, where the services and applications can run independently from a particular computer or server configuration making hardware less important.

Specifically, the cloud computing system 600 includes at least one client computer 602. The client computer 602 may be any device through the use of which a distributed computing environment may be accessed to perform the methods disclosed herein, for example, a traditional computer, portable computer, mobile phone, personal digital assistant, tablet to name a few. The client computer 602 includes memory such as random access memory (“RAM”), read-only memory (“ROM”), mass storage device, or any combination thereof. The memory functions as a computer usable storage medium, otherwise referred to as a computer readable storage medium, to store and/or access computer software and/or instructions.

The client computer 602 also includes a communications interface, for example, a modem, a network interface (such as an Ethernet card), a communications port, a PCMCIA slot and card, wired or wireless systems, etc. The communications interface allows communication through transferred signals between the client computer 602 and external devices including networks such as the Internet 604 and cloud data center 606. Communication may be implemented using wireless or wired capability such as cable, fiber optics, a phone line, a cellular phone connection, radio waves or other communication channels.

The client computer 602 establishes communication with the Internet 604—specifically to one or more servers—to, in turn, establish communication with one or more cloud data centers 606. A cloud data center 606 includes one or more networks 610a, 610b, 610c managed through a cloud management system 608. Each network 610a, 610b, 610c includes resource servers 612a, 612b, 612c, respectively. Servers 612a, 612b, 612c permit access to a collection of computing resources and components that can be invoked to instantiate a virtual machine, process, or other resource for a limited or defined duration. For example, one group of resource servers can host and serve an operating system or components thereof to deliver and instantiate a virtual machine. Another group of resource servers can accept requests to host computing cycles or processor time, to supply a defined level of processing power for a virtual machine. A further group of resource servers can host and serve applications to load on an instantiation of a virtual machine, such as an email client, a browser application, a messaging application, or other applications or software.

The cloud management system 608 can comprise a dedicated or centralized server and/or other software, hardware, and network tools to communicate with one or more networks 610a, 610b, 610c, such as the Internet or other public or private network, with all sets of resource servers 612a, 612b, 612c. The cloud management system 608 may be configured to query and identify the computing resources and components managed by the set of resource servers 612a, 612b, 612c needed and available for use in the cloud data center 606. Specifically, the cloud management system 608 may be configured to identify the hardware resources and components such as type and amount of processing power, type and amount of memory, type and amount of storage, type and amount of network bandwidth and the like, of the set of resource servers 612a, 612b, 612c needed and available for use in the cloud data center 606. Likewise, the cloud management system 608 can be configured to identify the software resources and components, such as type of Operating System (“OS”), application programs, and the like, of the set of resource servers 612a, 612b, 612c needed and available for use in the cloud data center 606.

The present invention is also directed to computer products, otherwise referred to as computer program products, to provide software to the cloud computing system 600. Computer products store software on any computer useable medium, known now or in the future. Such software, when executed, may implement the methods according to certain embodiments of the invention. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, Micro-Electro-Mechanical Systems (“MEMS”), nanotechnological storage device, etc.), and communication mediums (e.g., wired and wireless communications networks, local area networks, wide area networks, intranets, etc.). It is to be appreciated that the embodiments described herein may be implemented using software, hardware, firmware, or combinations thereof.

The cloud computing system 600 of FIG. 8 is provided only for purposes of illustration and does not limit the invention to this specific embodiment. It is appreciated that a person skilled in the relevant art knows how to program and implement the invention using any computer system or network architecture. FIG. 1 illustrates a simplified embodiment of the present invention.

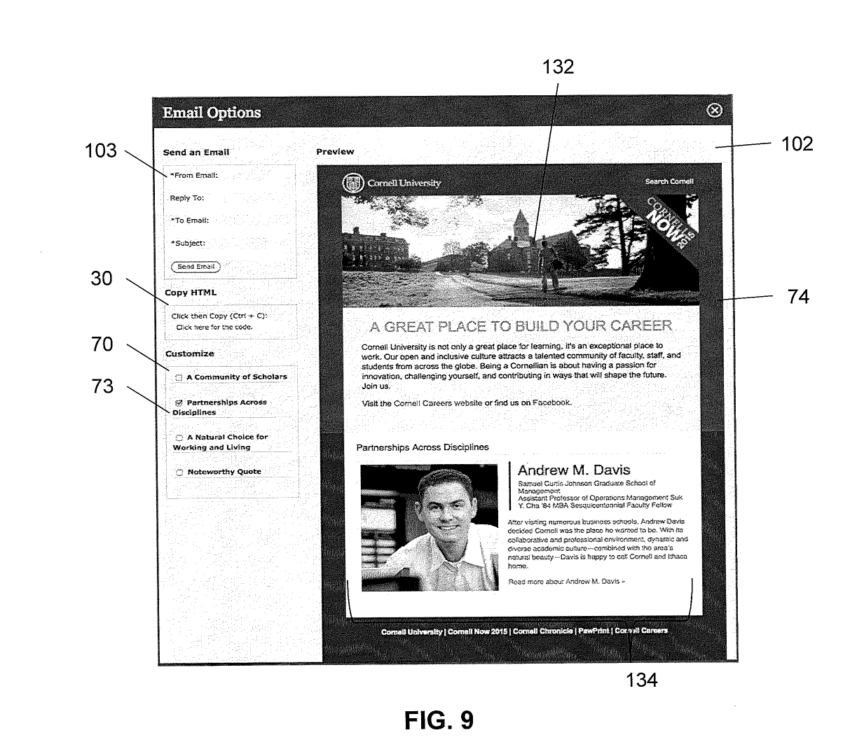

FIG. 9 illustrates an embodiment of a user interface 102 according to the present invention. This embodiment includes an example of an output creation component 70 having an output creation interface 73. The resulting output 74 is configured as an organization promotional document. The illustrated embodiment includes an email component 103 configured to permit exporting a unit 134 or an output 74 via email. The illustrated embodiment is also configured to permit sending the curator a link via an origination component 30.

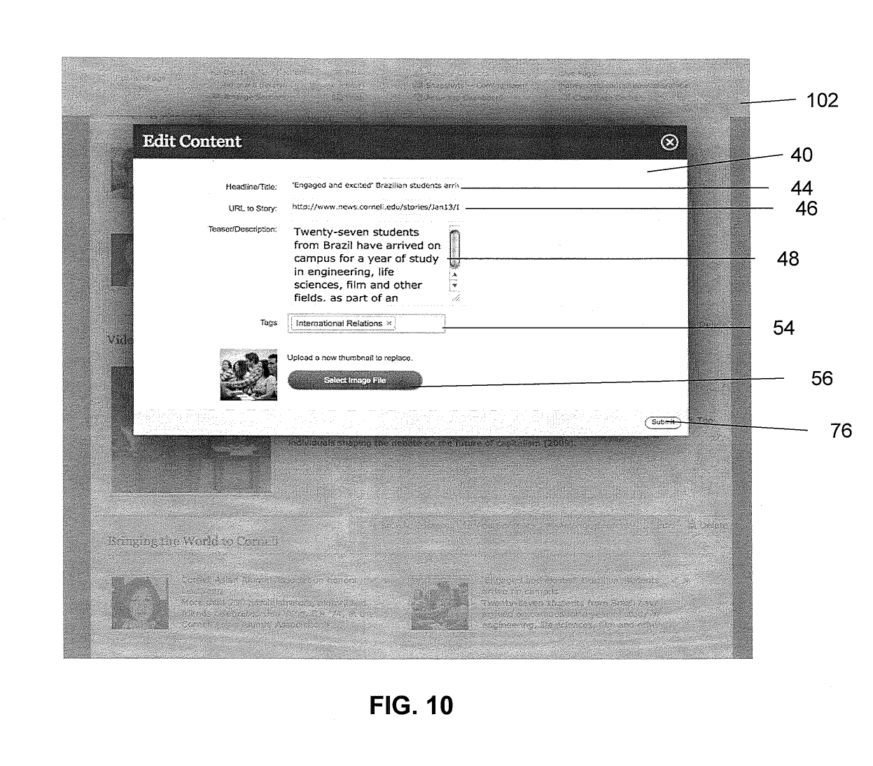

FIG. 10 also illustrates a user interface 102. Such user interface 102 includes a curation component 40 having a title field 44, a link field 46, a summary field 48, a tag field 54 configured to permit adding tags, a subunit field 56 configured to identify other subunits to pair with the current subunit, and a publication button 76.

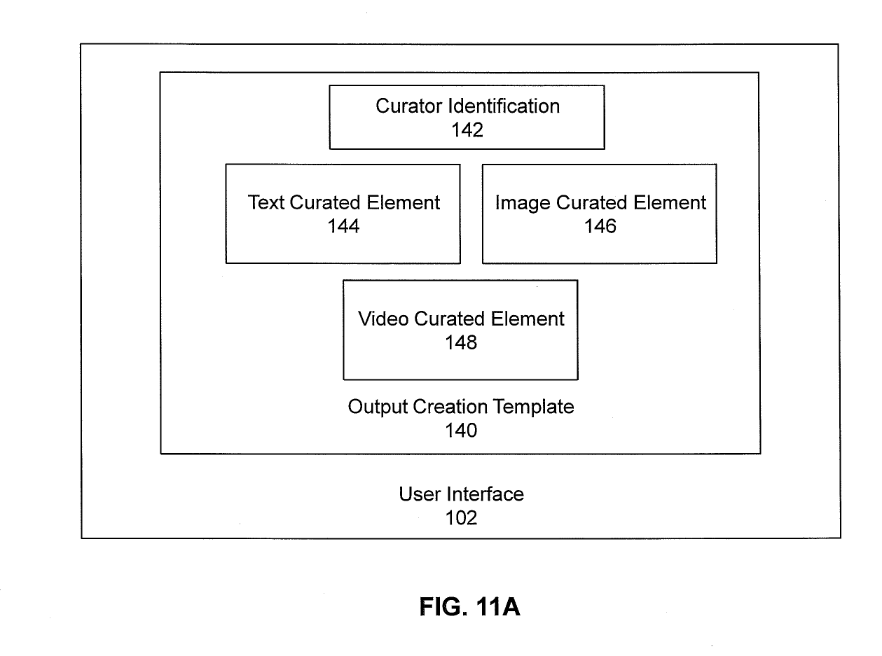

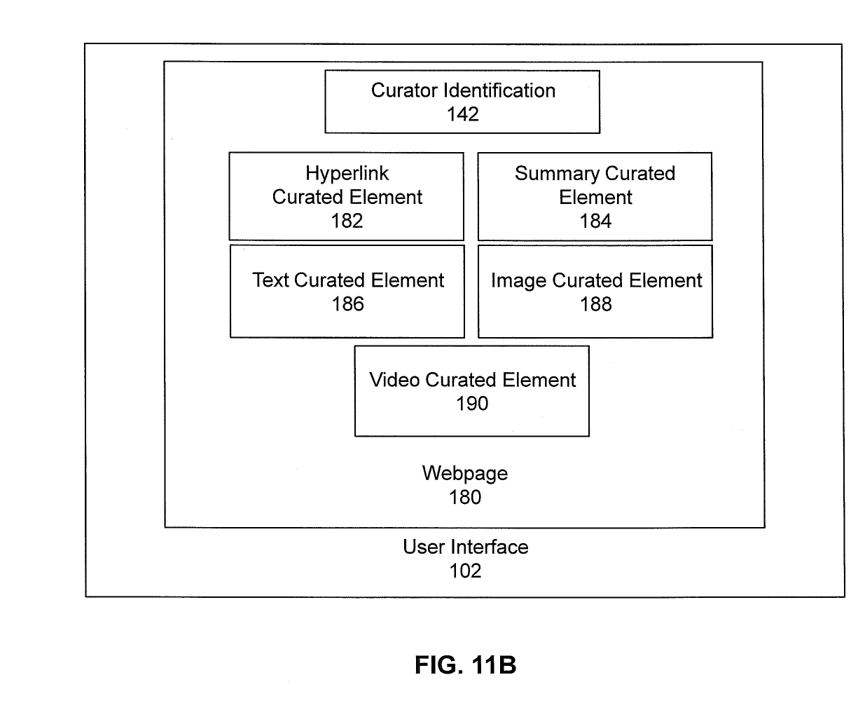

FIG. 11A illustrates a user interface 102 showing an output creation template 140. The illustrated embodiment is configured to facilitate creating an output 74 such as an e-book. An e-book may include a curator's identification 142, text curated element 144, image curated element 146, and video curated element 148. In certain embodiments, the video curated element includes a live video feed.

FIG. 11B illustrates a user interface 102 showing a webpage output 180. Such webpage 180 includes a curator identification 142, hyperlink curated element 182, summary curated element 184, text curated element 186, image curated element 188, and video curated element 190.

FIG. 12A-FIG. 12C also illustrate embodiments of a user interface 102 that include a search query field 104 and search results 106. In such embodiments, a user may enter a search query into the search field 104 and the system runs a search of only the published content, only the repository, or both, depending on the access granted to the user or the selection of the user. The search results 106 are displayed in an arrangement according to the relationship between the topics 108 and subtopics 110. The search results 106 may be arranged by topic 108/subtopic 110 first, then within each category further ranked by relevance of the content to the search query. In the embodiments illustrated in FIG. 12A and FIG. 12C, the user must click through the subtopics 110 to view the units/subunits. In the embodiment illustrated in FIG. 12B, certain units and subunits are illustrated on the same page as the topic 108 and subtopic 110 level information.

FIG. 12D and FIG. 12E illustrate an embodiments of a user interface 102 displaying search results 106 without the search query field. Such a search result 106 embodiments illustrate a larger set of the taxonomy, possibly all of the topics available in the taxonomy, and not merely the relevant topic 108 and sub-topics 110.

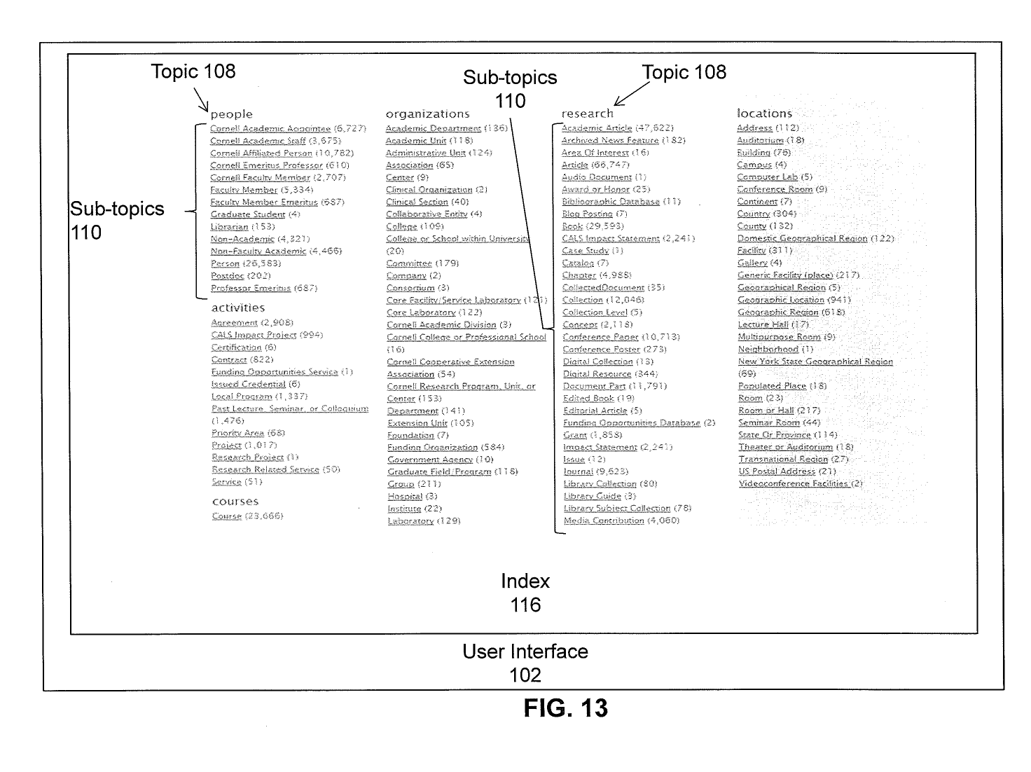

FIG. 13 illustrates a user interface 102 displaying an index 116 of topics 108 and sub-topics 110.

The described embodiments are to be considered in all respects only as illustrative and not restrictive, and the scope of the present invention is not limited to the foregoing description. Those of skill in the art may recognize changes, substitutions, adaptations and other modifications that may nonetheless come within the scope of the present invention and range of the present invention.

We claim:

1. An information system by which verified content may be provided to one or more users comprising:
an origination component that aggregates links to information of an organization to create a database of aggregated links and content for possible production of one or more content pages;
a curation component that subjects the content to one or more management activities, said one or more management activities including organizing the content by at least topic and as said one or more content pages; and
a publication component that at least offers said one or more content pages to users.

2. A method of organizing selected information comprising:
selecting content for inclusion in the information system;
aggregating links for the selected content;
creating a database of the aggregated links;
identifying the content by at least one or more topic; and
arranging the identified content into one or more content pages.

3. An information system by which verified and easily searchable content may be provided to one or more users, comprising:
a processor;
a main memory in communication with the processor via a communication infrastructure and storing instructions that, when executed by the processor, cause the processor to:
obtain a content subunit that either contains or is associated with content;
assess whether the content meets certain criteria;
if the certain content meets selected criteria, tagging subunit with a topic tag or a subtopic tag; and
publish subunit for viewing by system users.

4. The system of claim 3, wherein the assessing whether the content meets certain criteria is comprised of at least one, or any combination, of the following steps:
a. examining whether the content is or includes a primary source;
b. investigating whether the content was created by a member or members of the organization;
c. researching whether the content has been approved by a member or members of the organization;
d. considering whether the content was subjected to or approved after a peer-review process;
e. establishing whether the content was subjected to or approved after an editorial review process;
f. ascertaining whether the content has been authorized by a subject matter expert;
g. asking subject matter expert to review and approve the content;
h. cross-checking the content with other information;
i. conducting observations, calculations, or experiments related to the content;
j. discerning whether content includes appropriate citations;
k. ascertaining whether any copyright, contract rights, or other legal rights may limit rights to publish the content; or
l. discovering whether content is an opinion or other information not meant to be true or false.

5. The system of claim 3, wherein a plurality of subunits are obtained, each subunit either contains or is associated with content and the content of at least two of said plurality of subunits meet the criteria, such at least two of said plurality of subunits that meet the criteria are combined to form a unit.

6. The system of claim 3, wherein the main memory in communication with the processor via the communication infrastructure and storing instructions that, when executed by the processor, further causes the processor to:
provide a search query field in which users may enter a search query; and
exhibit results of relevant units by displaying at least a topic or subtopic in a search results user interface.

7. The system of claim 6, wherein the search results user interface displays at least a topic and a subtopic.

8. The system of claim 6, wherein the search results user interface displays at least a topic and a subtopic and the subtopics are ranked based on relevance to the search query.

9. The system of claim 6, wherein the search results user interface displays at least a topic, a subtopic, and a link, and the links are ranked based on relevance to the search query.

10. The system of claim 3, the main memory in communication with the processor via the communication infrastructure and storing instructions that, when executed by the processor, further causes the processor to:
using an output template to create an output that incorporates at least one subunit.

11. The system of claim 10, wherein the output is an email.

12. The system of claim 10, wherein the output is a presentation.

13. The system of claim 10, wherein the output is a printed document.

14. The system of claim 10, wherein the output is a digital file.

15. The system of claim 3, the main memory in communication with the processor via the communication infrastructure and storing instructions that, when executed by the processor, further causes the processor to:
decide whether content should be published or not published; and
storing not published content in a non-public repository.

16. The system of claim 15, the main memory in communication with the processor via the communication infrastructure and storing instructions that, when executed by the processor, further causes the processor to:
permit selected users, but not all users, to access non-public content.

17. The system of claim 3, the main memory in communication with the processor via the communication infrastructure and storing instructions that, when executed by the processor, further causes the processor to:
determine whether a source of content subunit meets certain criteria before the publishing step; and
if the source meets certain criteria, pre-approve the source for publishing content subunits upon identifying the source and without review of the content subunit.

18. The system of claim 3, the main memory in communication with the processor via the communication infrastructure and storing instructions that, when executed by the processor, further causes the processor to:
branding with curator information a unit or output created using the published subunit such that users can easily identify the curator.

19. The system of claim 3, the main memory in communication with the processor via the communication infrastructure and storing instructions that, when executed by the processor, further causes the processor to:
require users to include a source identifier with each subunit.

20. The system of claim 19, wherein the source identifier is a hyperlink to a website.

21. A system of claim 19, wherein the source identifier is a QR code.
